(19) United States
(12) Patent Application Publication
(10) Pub. No.: US 2018/0307350 A1
(43) Pub. Date: Oct. 25, 2018

(54) CONDUCTIVE FILM AND TOUCH PANEL

(71) Applicant: FUJIFILM Corporation, Tokyo (JP)

(72) Inventor: Katsuyuki NUKUI, Ashigarakami-gun (JP)

(73) Assignee: FUJIFILM Corporation, Tokyo (JP)

(21) Appl. No.: 16/019,059

(22) Filed: Jun. 26, 2018

Related U.S. Application Data
(63) Continuation of application No. PCT/JP2016/084462, filed on Nov. 21, 2016.

(30) Foreign Application Priority Data
Jan. 22, 2016 (JP) 2016-010412

(51) Int. Cl. G06F 3/044

(52) U.S. Cl. CPC G06F 3/044; G06F 2203/04112

(57) ABSTRACT

A conductive film is installed on the display unit of the display device. The conductive film has a first conductive portion having a first wiring pattern in which a plurality of first openings of congruent convex pentagons constituted by thin metallic wires are arranged, and a second conductive portion disposed in the form of a layer to overlap at least a part of the first conductive portion with a gap therebetween. The second conductive portion has a second wiring pattern in which a plurality of openings constituted by thin metallic wires are provided. When viewed in a lamination direction in which the first conductive portion and the second conductive portion overlap each other, a coefficient of variation of an opening area is less than 52% in an opening group formed by the first wiring pattern of the first conductive portion and the second wiring pattern of the second conductive portion.

### CROSS-REFERENCE TO RELATED APPLICATIONS

This application is a Continuation of PCT International Application No. PCT/JP2016/84462, filed on Nov. 21, 2016, which claims priority under 35 U.S.C. § 119(a) to Japanese Patent Application No. 2016-010412, filed on Jan. 22, 2016. Each of the above application(s) is hereby expressly incorporated by reference, in its entirety, into the present application.

### BACKGROUND OF THE INVENTION

### 1. Field of the Invention

The present invention relates to a conductive film which is disposed on a display unit of a display device and used as a touch sensor, and a touch panel provided with the conductive film, and particularly, to a conductive film in which moire and noise less occur regardless of the resolution of a display unit of a display device and the recognition of a display image is not hindered by gloss of a thin metallic wire caused by incidence rays at a specific angle, and a touch panel provided with the conductive film.

### 2. Description of the Related Art

In various kinds of electronic equipment including portable information equipment such as tablet computers and smartphones, touch panels, which are used in combination with a display device such as a liquid crystal display device to allow an input operation to electronic equipment by contact with a screen, have been in widespread use in recent years.

As the touch panel, a conductive film in which a conductive layer is formed on a transparent substrate is used.

The conductive layer is made of a transparent conductive oxide such as indium tin oxide (ITO), or a metal other than the transparent conductive oxide. The metal has advantages in that patterning is more easily performed on it, and it has more excellent flexibility and a lower resistance than the transparent conductive oxide. Accordingly, a metal such as copper or silver is used for a thin conductive wire in a touch panel or the like.

In JP2014-115694A, a touch panel using a thin metallic wire is described. In JP2014-115694A, the touch panel is a capacitance sensor provided with a base material, a plurality of Y-electrode patterns, a plurality of X-electrode patterns, a plurality of jumper insulating layers, a plurality of jumper wires, and a transparent insulating layer. Each of the plurality of Y-electrode patterns has a substantially rhombus shape, and these are arranged in matrix in an X-direction and a Y-direction on a surface of the base material such that the apexes thereof are opposed to each other. Each of the plurality of X-electrode patterns has substantially the same rhombus shape as the Y-electrode pattern. In JP2014-115694A, the X-electrode patterns and the Y-electrode patterns are rhombus mesh patterns.

### SUMMARY OF THE INVENTION

In general, a conductive film which is used for a touch sensor employs a rhombus mesh pattern formed of two kinds of equally spaced parallel lines, like the substantially rhombus pattern of JP2014-115694A.

In a case where a conductive film is applied in a touch panel, it is necessary to give consideration to a visual interference effect caused by the lamination of a periodical pattern of a black matrix included in a liquid crystal display device having the touch panel and a rhombus mesh pattern of the conductive film.

Specifically, in a case where the periodicity of the black matrix pattern and the periodicity of the rhombus mesh pattern are close to each other, an interference pattern with a relatively long periodicity is generated, and a stripe pattern is visually recognized by a user of the touch panel. The above-described interference pattern with a relatively long periodicity is also called moire.

In order to avoid moire, the angle between two kinds of parallel lines of the rhombus mesh pattern is adjusted, the interval distance between the parallel lines is adjusted, or the installation angles of the black matrix pattern of the liquid crystal display device and the mesh pattern are adjusted so as to shift the periodicities of the black matrix pattern and the mesh pattern. As in JP2013-214545A, the rhombus pattern may be made non-uniform to improve the rhombus pattern.

Specifically, irregularity is introduced to the interval distance between the parallel lines for forming the rhombus mesh pattern within a predetermined range to further suppress the occurrence of moire of the black matrix pattern and the mesh pattern.

However, in a case where a mesh pattern in which no moire occurs is actually designed for an arbitrary liquid crystal display device, efforts are required for producing a plurality of practical samples thought to be preferred based on the simulation result and for actually performing overlapping evaluation to the liquid crystal display device in order to select an optimum mesh pattern.

In addition, in a case where the same mesh pattern is applied to a different liquid crystal display device having a different resolution, there is little possibility that the mesh pattern optimized for a liquid crystal display device having a different resolution is suitable, since the black matrix has a different periodicity. Thus, it is necessary to design a mesh pattern for each resolution of a liquid crystal display device and to perform practical confirmation. There are liquid crystal display device models with a variety of resolutions, and a long period of time is demanded to optimize a mesh pattern for each model, so this becomes a problem in developing and providing a touch sensor for many touch panels.

In addition, in a case where a thin wire shape of the mesh pattern is visually recognized as gloss due to the scattering of incidence rays at a specific angle, such as afternoon sunlight, caused by thin wires constituting the mesh pattern, the gloss may be visually recognized in a continuous and wide range in the rhombus mesh pattern, and may hinder the recognition of an image displayed by the liquid crystal display device.

In JP2013-69261A, it is considered that the shape of a mesh cell included in the mesh pattern is determined at random to significantly reduce the periodicity of the mesh pattern itself, and to make interference between the periodicity of the mesh pattern and the periodicity of the black matrix pattern hardly occur, thereby avoiding the occurrence of moire. In a case where a random mesh pattern is used, suitability for liquid crystal display devices having different resolutions is increased. Thus, it was possible to confirm that moire hardly occurs, but the generation of noticeable glare-like noise was found. A cause of the noise is thought to be local non-uniformity of the random mesh pattern. In a case where a thin wire shape is visually recognized as gloss due to the scattering of incidence rays at a specific angle, such as afternoon sunlight, caused by thin wires constituting the random mesh pattern, the gloss is not generated in a continuous range in the random mesh pattern, and does not hinder the recognition of an image displayed by the liquid crystal display device.

In a case where a touch sensor having a mesh pattern is incorporated in a touch panel, it is desirable that no moire occurs and no noise is visually recognized, and currently, it is demanded that suitability for liquid crystal display devices having different resolutions is increased, and gloss of thin wires constituting the mesh pattern caused by incidence rays at a specific angle does not hinder the recognition of a display image of the image display device.

An object of the invention is to provide a conductive film which solves the problems based on the above-described related art, and in which moire and noise less occur regardless of the resolution of a display unit of a display device and the recognition of a display image is not hindered by gloss of a thin metallic wire caused by incidence rays at a specific angle, and a touch panel provided with the conductive film.

In order to achieve the object, according to a first aspect of the invention, there is provided a conductive film which is installed on a display unit of a display device, comprising: a first conductive portion having a first wiring pattern in which a plurality of first openings of congruent convex pentagons constituted by thin metallic wires are arranged; and a second conductive portion disposed in the form of a layer to overlap at least a part of the first conductive portion with a gap therebetween, in which the second conductive portion has a second wiring pattern in which a plurality of openings constituted by thin metallic wires are provided, and when viewed in a lamination direction in which the first conductive portion and the second conductive portion overlap each other, a coefficient of variation of an opening area is less than 52% in an opening group formed by the first wiring pattern of the first conductive portion and the second wiring pattern of the second conductive portion.

It is preferable that the opening of the second wiring pattern of the second conductive portion has a polygonal shape and has an apex at a center of gravity position of the first opening of the congruent convex pentagon.

It is preferable that the opening of the second wiring pattern of the second conductive portion has a polygonal shape, and a perpendicular bisector of each side of the first opening of the congruent convex pentagon constitutes at least one of sides of the opening.

It is preferable that the convex pentagon has a side a, a side b, a side c, a side d, and a side e, and satisfies angle A+angle B+angle C=180° in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a, and it is preferable that the side b of the convex pentagon and the side c of the convex pentagon are matched, and the side e is disposed on a straight line.

It is preferable that the convex pentagon has a side a, a side b, a side c, a side d, and a side e, and satisfies angle A+angle B+angle C=180° in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a, and it is preferable that the sides b of the plurality of convex pentagons and the sides c of the plurality of convex pentagons are matched, and the sides e of the plurality of convex pentagons are disposed by changing a predetermined distance from a straight line.

It is preferable that the convex pentagon has a side a, a side b, a side c, a side d, and a side e, and satisfies angle A+angle B+angle D=180° and side a=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the convex pentagon has a side a, a side b, a side c, a side d, and a side e, and satisfies angle C=angle E=90°, side a=side e, and side c=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the convex pentagon has a side a, a side b, a side c, a side d, and a side e, and satisfies angle B×2+angle C=360°, angle D×2+angle A=360°, and side a=side b=side c=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the convex pentagon has a side a, a side b, a side c, a side d, and a side e, and satisfies angle E×2+angle B=360°, angle D×2+angle C=360°, and side a=side b=side c=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the convex pentagon has a side a, a side b, a side c, a side d, and a side e, and satisfies angle A=90°, angle B+angle E=180°, angle D×2+angle E=360°, angle C×2+angle B=360°, and side a=side b=(side c+side e) in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the convex pentagon has a side a, a side b, a side c, a side d, and a side e, and satisfies angle A=90°, angle C+angle E=180°, angle B×2+angle C=360°, and side d=side e=(side a×2+side c) in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the convex pentagon has a side a, a side b, a side c, a side d, and a side e, and satisfies angle A=90°, angle C+angle E=180°, angle B×2+angle C=360°, and side a×2=side d=(side c+side e) in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

It is preferable that the thin metallic wire has a wire width of 0.5 μm to 5 μm.

It is preferable that the first conductive portion is provided on one surface of a transparent base, and the second conductive portion is provided on the other surface of the transparent base.

For example, the first wiring pattern and the second wiring pattern are superimposed on a pixel arrangement pattern of the display unit. In addition, for example, the pixel arrangement pattern is a black matrix pattern of the display unit.

According to a second aspect of the invention, there is provided a touch panel comprising: the conductive film according to the first aspect which is disposed on a display unit of a display device.

According to the invention, it is possible to reduce the occurrence of moire and noise regardless of the resolution of a display unit of a display device. Moreover, it is possible to suppress hindering of the recognition of a display image by gloss of a thin metallic wire caused by incidence rays at a specific angle.

### BRIEF DESCRIPTION OF THE DRAWINGS

FIG. 1 is a schematic diagram illustrating a display device having a conductive film according to an embodiment of the invention.

FIG. 2 is a schematic diagram illustrating an example of a pixel arrangement pattern of a display unit.

FIG. 3 is a schematic plan view illustrating a touch sensor using the conductive film according to the embodiment of the invention.

FIG. 4 is a schematic cross-sectional view illustrating a first example of the conductive film according to the embodiment of the invention.

FIG. 5 is a schematic cross-sectional view illustrating a second example of the conductive film according to the embodiment of the invention.

FIG. 6 is a schematic diagram illustrating a first example of a convex pentagon.

FIG. 7 is a schematic diagram illustrating a first wiring pattern using the first example of the convex pentagon.

FIG. 8 is a schematic diagram illustrating a modification example of the first example of the convex pentagon.

FIG. 9 is a schematic diagram illustrating a first wiring pattern using the modification example of the first example of the convex pentagon.

FIG. 10 is a schematic diagram illustrating a second example of the convex pentagon.

FIG. 11 is a schematic diagram illustrating a first wiring pattern using the second example of the convex pentagon.

FIG. 12 is a schematic diagram illustrating a third example of the convex pentagon.

FIG. 13 is a schematic diagram illustrating a first wiring pattern using the third example of the convex pentagon.

FIG. 14 is a schematic diagram illustrating a fourth example of the convex pentagon.

FIG. 15 is a schematic diagram illustrating a first wiring pattern using the fourth example of the convex pentagon.

FIG. 16 is a schematic diagram illustrating a fifth example of the convex pentagon.

FIG. 17 is a schematic diagram illustrating a first wiring pattern using the fifth example of the convex pentagon.

FIG. 18 is a schematic diagram illustrating a sixth example of the convex pentagon.

FIG. 19 is a schematic diagram illustrating a first wiring pattern using the sixth example of the convex pentagon.

FIG. 20 is a schematic diagram illustrating a seventh example of the convex pentagon.

FIG. 21 is a schematic diagram illustrating a first wiring pattern using the seventh example of the convex pentagon.

FIG. 22 is a schematic diagram illustrating an eighth example of the convex pentagon.

FIG. 23 is a schematic diagram illustrating a first wiring pattern using the eighth example of the convex pentagon.

FIG. 24 is a schematic diagram illustrating a ninth example of the convex pentagon.

FIG. 25 is a schematic diagram illustrating a first wiring pattern using the ninth example of the convex pentagon.

FIG. 26 is a schematic diagram illustrating a tenth example of the convex pentagon.

FIG. 27 is a schematic diagram illustrating a first wiring pattern using the tenth example of the convex pentagon.

FIG. 28 is a schematic diagram illustrating an eleventh example of the convex pentagon.

FIG. 29 is a schematic diagram illustrating a first wiring pattern using the eleventh example of the convex pentagon.

FIG. 30 is a schematic diagram illustrating a twelfth example of the convex pentagon.

FIG. 31 is a schematic diagram illustrating a first wiring pattern using the twelfth example of the convex pentagon.

FIG. 32 is a schematic diagram illustrating a thirteenth example of the convex pentagon.

FIG. 33 is a schematic diagram illustrating a first wiring pattern using the thirteenth example of the convex pentagon.

FIG. 34 is a schematic diagram illustrating a fourteenth example of the convex pentagon.

FIG. 35 is a schematic diagram illustrating a first wiring pattern using the fourteenth example of the convex pentagon.

FIG. 36 is a schematic diagram illustrating a fifteenth example of the convex pentagon.

FIG. 37 is a schematic diagram illustrating a first wiring pattern using the fifteenth example of the convex pentagon.

FIG. 38 is a schematic diagram illustrating an example of the first wiring pattern of the conductive film according to an embodiment of the invention.

FIG. 39 is a schematic diagram illustrating a first example of the second wiring pattern of the conductive film according to an embodiment of the invention.

FIG. 40 is a schematic diagram illustrating a second example of the second wiring pattern of the conductive film according to an embodiment of the invention.

FIG. 41 is a schematic diagram for explaining the second wiring pattern.

FIG. 42 is a schematic diagram illustrating a first example of the first wiring pattern using the convex pentagon of the first example.

FIG. 43 is a schematic diagram illustrating a first example of the second wiring pattern using the convex pentagon of the first example.

FIG. 44 is a schematic diagram illustrating a second example of the first wiring pattern using the convex pentagon of the first example.

FIG. 45 is a schematic diagram illustrating a second example of the second wiring pattern using the convex pentagon of the first example.

FIG. 46 is a schematic diagram illustrating a third example of the first wiring pattern using the convex pentagon of the first example.

FIG. 47 is a schematic diagram illustrating a third example of the second wiring pattern using the convex pentagon of the first example.

FIG. 48 is a schematic diagram illustrating the first wiring pattern using the convex pentagon of the second example.

FIG. 49 is a schematic diagram illustrating the second wiring pattern using the convex pentagon of the second example.

FIG. 50 is a schematic diagram illustrating the first wiring pattern using the convex pentagon of the third example.

FIG. 51 is a schematic diagram illustrating the second wiring pattern using the convex pentagon of the third example.

FIG. 52 is a schematic diagram illustrating the first wiring pattern using the convex pentagon of the fourth example.

FIG. 53 is a schematic diagram illustrating the second wiring pattern using the convex pentagon of the fourth example.

FIG. 54 is a schematic diagram illustrating the first wiring pattern using the convex pentagon of the fifth example.

FIG. 55 is a schematic diagram illustrating the second wiring pattern using the convex pentagon of the fifth example.

FIG. 56 is a schematic diagram illustrating the first wiring pattern using the convex pentagon of the sixth example.

FIG. 57 is a schematic diagram illustrating the second wiring pattern using the convex pentagon of the sixth example.

FIG. 58 is a schematic diagram illustrating the first wiring pattern using the convex pentagon of the seventh example.

FIG. 59 is a schematic diagram illustrating the second wiring pattern using the convex pentagon of the seventh example.

FIG. 60 is a schematic diagram illustrating the first wiring pattern using the convex pentagon of the eighth example.

FIG. 61 is a schematic diagram illustrating the second wiring pattern using the convex pentagon of the eighth example.

FIG. 62 is a schematic diagram illustrating the first wiring pattern using the convex pentagon of the ninth example.

FIG. 63 is a schematic diagram illustrating the second wiring pattern using the convex pentagon of the ninth example.

FIG. 64 is a schematic diagram illustrating the first wiring pattern using the convex pentagon of the tenth example.

FIG. 65 is a schematic diagram illustrating the second wiring pattern using the convex pentagon of the tenth example.

FIG. 66 is a schematic diagram illustrating the first wiring pattern using the convex pentagon of the eleventh example.

FIG. 67 is a schematic diagram illustrating the second wiring pattern using the convex pentagon of the eleventh example.

FIG. 68 is a schematic diagram illustrating the first wiring pattern using the convex pentagon of the twelfth example.

FIG. 69 is a schematic diagram illustrating the second wiring pattern using the convex pentagon of the twelfth example.

FIG. 70 is a schematic diagram illustrating the first wiring pattern using the convex pentagon of the thirteenth example.

FIG. 71 is a schematic diagram illustrating the second wiring pattern using the convex pentagon of the thirteenth example.

FIG. 72 is a schematic diagram illustrating the first wiring pattern using the convex pentagon of the fourteenth example.

FIG. 73 is a schematic diagram illustrating the second wiring pattern using the convex pentagon of the fourteenth example.

FIG. 74 is a schematic diagram illustrating the first wiring pattern using the convex pentagon of the fifteenth example.

FIG. 75 is a schematic diagram illustrating the second wiring pattern using the convex pentagon of the fifteenth example.

FIG. 76 is a schematic diagram illustrating a wiring pattern with rhombus openings.

### DESCRIPTION OF THE PREFERRED EMBODIMENTS

Hereinafter, a conductive film and a touch panel according to the invention will be described in detail based on preferable embodiments illustrated in the accompanying drawings.

In the following description, the expression “to” indicating a numerical value range includes numerical values on both sides of “to”. For example, in a case where ε is a numerical value α to a numerical value β, the range of ε includes the numerical value α and the numerical value β, and is expressed as α≤ε≤β in mathematical symbols.

An angle expressed using the expression such as “parallel”, “vertical”, or “perpendicular” includes an error range that is generally permitted in the technical field. The expression “the same” includes an error range that is generally permitted in the technical field.

The expression “transparent” means that the light transmittance is at least 60% or greater, preferably 75% or greater, more preferably 80% or greater, and even more preferably 85% or greater in a visible light wavelength range ranging from 400 to 800 nm. The light transmittance is measured using “Plastics—Determination Of Total Luminous Transmittance And Reflectance” specified in JIS K 7375: 2008.

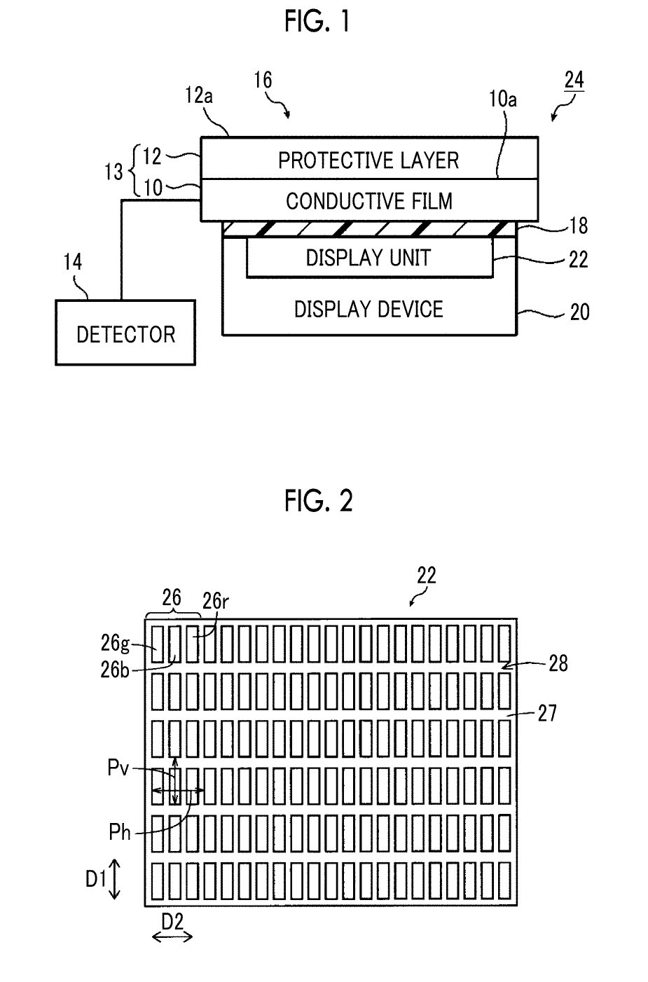

FIG. 1 is a schematic diagram illustrating a display device having a conductive film according to an embodiment of the invention, and FIG. 2 is a schematic diagram illustrating an example of a pixel arrangement pattern of a display unit.

As illustrated in FIG. 1, a conductive film 10 is provided on a display unit 22 of a display device 20 via, for example, an optically transparent layer 18.

A protective layer 12 is provided on a front surface 10a of the conductive film 10. The conductive film 10 is connected to a detector 14.

The conductive film 10 and the protective layer 12 constitute a touch sensor 13, and the conductive film 10, the protective layer 12, and the detector 14 constitute a touch panel 16. The touch panel 16 and the display device 20 constitute display equipment 24.

A front surface 12a of the protective layer 12 serves as a visual recognition surface of a display object displayed in the display unit 22. In addition, the front surface 12a of the protective layer 12 serves as a touch surface of the touch panel 16.

The detector 14 is formed of a known detector which is used in the detection of a capacitance-type touch sensor or a resistance film-type touch sensor. In the touch sensor 13, in the capacitance type, a position where the capacitance changes by the contact of a finger or the like on the front surface 12a of the protective layer 12 is detected by the detector 14. In the resistance film type, a position where the resistance changes is detected by the detector 14.

The protective layer 12 is provided to protect the conductive film 10. The configuration of the protective layer 12 is not particularly limited. For example, glass, polycarbonate (PC), polyethylene terephthalate (PET), or an acrylic resin such as a polymethylmethacrylate resin (PMMA) is used. Since the front surface 12a of the protective layer 12 serves as a touch surface as described above, a hard coat layer may be provided on the front surface 12a as necessary.

The configuration of the optically transparent layer 18 is not particularly limited as long as the optically transparent layer is optically transparent, has an insulating property, and can stably fix the conductive film 10. As the optically transparent layer 18, for example, an optically transparent pressure sensitive adhesive (OCA, optical clear adhesive) or an optically transparent resin (OCR, optical clear resin) such as an ultraviolet (UV) curable resin can be used. The optically transparent layer 18 may be partially hollow.

A configuration in which the conductive film 10 is provided over the display unit 22 with a gap formed therebetween without the optically transparent layer 18 may be employed. This gap is also called an air gap.

The display device 20 is, for example, a liquid crystal display device, and in this case, the display unit 22 is a liquid crystal display cell. The display unit 22 is provided with a black matrix having a pixel arrangement pattern as illustrated in FIG. 2.

The display device is not limited to the liquid crystal display device, and may be an organic electroluminescence (organic EL) display device. In this case, the display unit is an organic electroluminescence (organic EL) element.

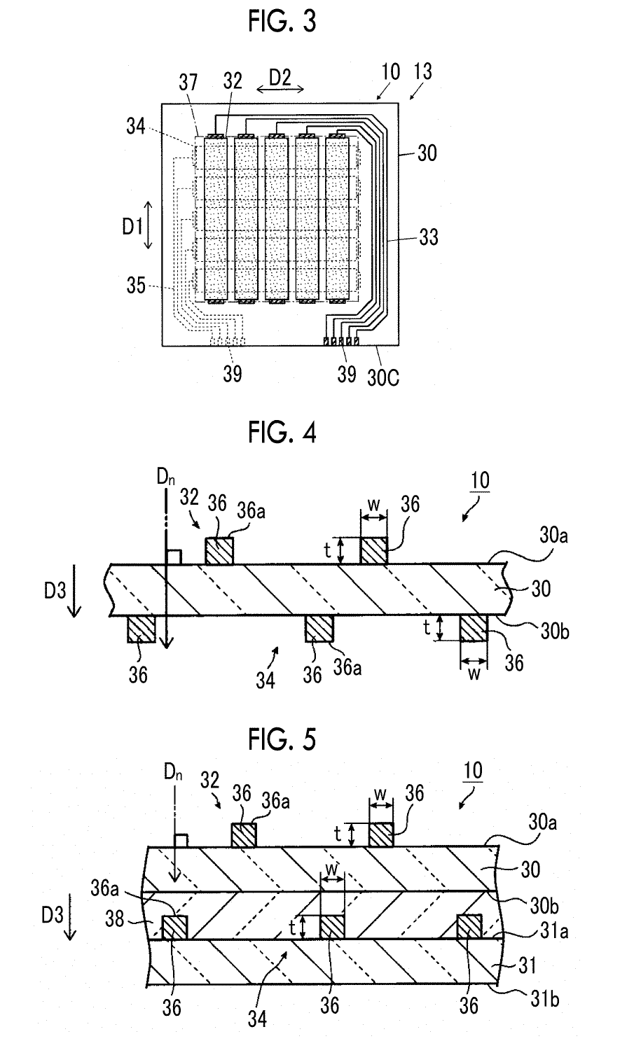

As illustrated in FIG. 2, in the display unit 22, a plurality of pixels 26 are arranged in matrix, and constitutes a predetermined pixel arrangement pattern. For example, three sub-pixels, that is, a red sub-pixel 26r, a green sub-pixel 26g, and a blue sub-pixel 26b are arranged in a horizontal direction, and constitute one pixel 26. For example, one sub-pixel has a rectangular shape that is long in a vertical direction. An arrangement pitch of a pixel 26 in the horizontal direction, that is, a horizontal pixel pitch Ph and an arrangement pitch of the pixel 26 in the vertical direction, that is, a vertical pixel pitch Pv are substantially the same. That is, the shape constituted by one pixel 26 and a black matrix (BM) 27 surrounding the one pixel 26 is a square shape. The aspect ratio of one pixel 26 is not 1, and the length in the horizontal direction (horizontal) is larger than the length in the vertical direction (vertical). A first direction D1 and a second direction D2 perpendicular to the first direction D1, which are shown in FIG. 2, correspond to a first direction D1 and a second direction D2 in FIG. 3 to be described later.

The pixel arrangement pattern formed of red sub-pixels 26r, green sub-pixels 26g, and blue sub-pixels 26b of the plurality of pixels 26 is specified by a black matrix pattern 28 of the black matrix 27 surrounding the red sub-pixels 26r, the green sub-pixels 26g, and the blue sub-pixels 26b. The pixel arrangement pattern is determined in accordance with the resolution of the display device 20. The black matrix pattern 28 is also determined in accordance with the resolution of the display device 20.

Moire occurring when the display unit 22 and the conductive film 10 are superimposed occurs by interference between the black matrix pattern 28 of the black matrix 27 of the display unit 22 and a stiffness pattern of first conductive portions and second conductive portions of the conductive film 10, which will be described later. Therefore, strictly, the black matrix pattern 28 is a reverse pattern of the pixel arrangement pattern, but represents the same pattern herein.

The pixel arrangement pattern and the black matrix pattern 28 are not limited to the square grid, and may be a triangle grid.

Next, the conductive film 10 will be described based on FIGS. 3, 4, and 5.

FIG. 3 is a schematic plan view illustrating a touch sensor using the conductive film according to the embodiment of the invention. FIG. 4 is a schematic cross-sectional view illustrating a first example of the conductive film according to the embodiment of the invention. FIG. 5 is a schematic cross-sectional view illustrating a second example of the conductive film according to the embodiment of the invention.

The conductive film 10 is used for, for example, a capacitance-type touch sensor. As illustrated in FIG. 3, on a front surface 30a of a transparent base 30, a plurality of first conductive portions 32 are formed to extend in a first direction D1 and to be arranged in parallel in a second direction D2 perpendicular to the first direction D1, and a plurality of first peripheral wires 33 electrically connected to the plurality of first conductive portions 32 are arranged close to each other. The plurality of first peripheral wires 33 are collected into one terminal 39 at one side 30c of the transparent base 30.

Similarly, on a rear surface 30b of the transparent base 30, a plurality of second conductive portions 34 are formed to extend in the second direction D2 and to be arranged in parallel in the first direction D1, and a plurality of second peripheral wires 35 electrically connected to the plurality of second conductive portions 34 are arranged close to each other. The plurality of second peripheral wires 35 are collected into one terminal 39 at one side 30c of the transparent base 30. A second conductive portion 34 is disposed in the form of a layer to overlap at least a part of a first conductive portion 32 with a gap therebetween. More specifically, when viewed in a direction Dn (see FIGS. 4 and 5) vertical to one surface of the transparent base 30, the second conductive portion 34 is disposed to overlap at least a part of the first conductive portion 32. A lamination direction D3 (see FIGS. 4 and 5) in which the first conductive portion 32 and the second conductive portion 34 overlap each other is the same as the above-described vertical direction Dn (see FIGS. 4 and 5).

The plurality of first conductive portions 32 and the plurality of second conductive portions 34 function as a detecting electrode.

In the conductive film 10, a region where the plurality of first conductive portions 32 and the plurality of second conductive portions 34 are disposed to overlap each other in plan view in the transparent base 30 is a sensor region 37. The sensor region 37 is a region where the contact of a finger or the like, that is, a touch can be detected in a capacitance-type touch sensor.

All of the first conductive portions 32 and the second conductive portions 34, each formed of a thin metallic wire 36, form a mesh pattern provided with openings. The mesh patterns of the first conductive portions 32 and the second conductive portions 34 will be described later in detail.

Regarding the first peripheral wire 33 and the second peripheral wire 35, each of them may be formed of a thin metallic wire 36 or a conductive wire having a different wire width and a different thickness from those of the thin metallic wire 36. Each of the first peripheral wire 33 and the second peripheral wire 35 may be formed of, for example, a strip-like conductor. The constituent members of the conductive film 10 will be described later in detail.

The conductive film 10 is not limited to a conductive film for a capacitance-type touch sensor as described above, and may be used for a resistance film-type touch sensor. Also in a resistance film-type touch sensor, a region where a plurality of first conductive portions 32 and a plurality of second conductive portions 34 are disposed to overlap each other in plan view is a sensor region 37.

The conductive film 10 is not particularly limited. However, for example, as illustrated in FIG. 4, the first conductive portion 32 is provided on the front surface 30a of the transparent base 30, and the second conductive portion 34 is provided on the rear surface 30b of the transparent base 30. In a case where the first conductive portion 32 is provided on the front surface 30a of one transparent base 30, and the second conductive portion 34 is provided on the rear surface 30b, deviation in the positional relationship between the first conductive portion 32 and the second conductive portion 34 can be reduced even in a case where the transparent base 30 contracts.

As described above, the lamination direction D3 in which the first conductive portion 32 and the second conductive portion 34 overlap each other is the same as the above-described vertical direction Dn.

For example, as in a case of a conductive film 10 illustrated in FIG. 5, a configuration in which one conductive portion is provided on one transparent base 30 and on one transparent base 31, respectively, may be employed. The conductive film 10 may have a configuration in which a transparent base 31 in which a second conductive portion 34 is provided on a front surface 31a is laminated on a rear surface 30b of a transparent base 30 in which a first conductive portion 32 is provided on a front surface 30a of one transparent base 30 via an adhesive layer 38. The transparent base 31 has the same configuration as the transparent base 30. As the adhesive layer 38, the same one as the above-described optically transparent layer 18 can be used. In FIG. 5, as described above, a lamination direction D3 in which the first conductive portion 32 and the second conductive portion 34 overlap each other is the same as the above-described vertical direction Dn.

A wire width w of the thin metallic wire 36 is not particularly limited, but in a case where the thin metallic wire 36 is applied as the first conductive portion 32 and the second conductive portion 34, the wire width is preferably 0.5 μm to 5 μm. In a case where the wire width w of the thin metallic wire 36 is within the above range, a conductive portion having a low resistance can be relatively easily formed.

In a case where the thin metallic wire 36 is applied as a peripheral wire (lead-out wire), the wire width w of the thin metallic wire 36 is preferably 500 μm or less, more preferably 50 μm or less, and particularly preferably 30 μm or less. In a case where the wire width w is within the above range, a peripheral wire having a low resistance can be relatively easily formed.

In a case where the thin metallic wire 36 is applied as a peripheral wire in the conductive film 10, both the first conductive portion 32 and the second conductive portion 34 may form the same mesh pattern, and in that case, the wire width w is not particularly limited. However, the wire width is preferably 30 μm or less, more preferably 15 μm or less, even more preferably 10 μm or less, particularly preferably 9 μm or less, and most preferably 7 μm or less. In addition, the wire width is preferably 0.5 μm or greater, and more preferably 1.0 μm or greater. In a case where the wire width w is within the above range, a peripheral wire having a low resistance can be relatively easily formed. It is preferable that the peripheral wire forms a mesh pattern in a sensor sheet, since the uniformity of the resistance reduction due to the irradiation on the detection electrode and the peripheral wire can be increased in a step for pulse light irradiation from a xenon flash lamp in the formation of the first conductive portion 32 and the second conductive portion 34, and in a case where the pressure sensitive adhesive layer is laminated, the peeling strength of the first and second conductive portions 32 and 34 and the peripheral wire can be made constant, and thus the in-plane distribution can be reduced.

A thickness t of the thin metallic wire 36 is not particularly limited. However, the thickness is preferably 1 to 200 μm, more preferably 30 μm or less, even more preferably 20 μm or less, particularly preferably 0.01 to 9 μm, and most preferably 0.05 to 5 μm. In a case where the thickness t is within the above range, a detection electrode having a low resistance and excellent durability can be relatively easily formed.

Regarding the wire width w of the thin metallic wire 36 and the thickness t of the thin metallic wire 36, a cross-sectional image of the conductive film 10 including the thin metallic wires 36 is acquired, input to a personal computer, and displayed on a monitor. Horizontal lines are respectively drawn at two positions for specifying the above-described wire width w of the thin metallic wire 36, and the length between the horizontal lines is obtained. Accordingly, the wire width w of the thin metallic wire 36 can be obtained. In addition, horizontal lines are respectively drawn at two positions for specifying the thickness t of the thin metallic wire 36, and the length between the horizontal lines is obtained. Accordingly, the thickness t of the thin metallic wire 36 can be obtained.

Hereinafter, the members of the conductive film 10 will be described.

<Transparent Base>

Since the transparent base 30 and the transparent base 31 are the same, only the transparent base 30 will be described. The kind of the transparent base 30 is not particularly limited as long as the first conductive portion 32, the first peripheral wire 33, the second conductive portion 34, and the second peripheral wire 35 can be supported, but a plastic film is preferable.

As specific examples of the constituent material of the transparent base 30, plastic films having a melting point of about 290° C. or lower, such as polyethylene terephthalate (PET) (258° C.), polycycloolefin (134° C.), polycarbonate (250° C.), acrylic resin (128° C.), polyethylene naphthalate (PEN) (269° C.), polyethylene (PE) (135° C.), polypropylene (PP) (163° C.), polystyrene (230° C.), polyvinyl chloride (180° C.), polyvinylidene chloride (212° C.), and triacetylcellulose (TAC) (290° C.) are preferable, and PET, polycycloolefin, and polycarbonate are particularly preferable. The numerical values in the brackets are melting points.

The total light transmittance of the transparent base 30 is preferably 85% to 100%. The total light transmittance is measured using “Plastics—Determination Of Total Luminous Transmittance And Reflectance” specified in JIS K 7375: 2008.

A preferable aspect of the transparent base 30 is a treated substrate subjected to at least one selected from the group consisting of an atmospheric-pressure plasma treatment, a corona discharge treatment, and an ultraviolet irradiation treatment. By performing the above-described treatment, a hydrophilic group such as an OH group is introduced to the treated surface of the transparent base 30, and the adhesion of the first conductive portion 32, the first peripheral wire 33, the second conductive portion 34, and the second peripheral wire 35 to the transparent base 30 is further improved.

Among the above-described treatments, an atmospheric-pressure plasma treatment is preferable in view of further improving the adhesion of the first conductive portion 32, the first peripheral wire 33, the second conductive portion 34, and the second peripheral wire 35 to the transparent base 30.

As another preferable aspect of the transparent base 30, an undercoat layer including a polymer is provided on a surface where the first conductive portion 32, the first peripheral wire 33, the second conductive portion 34, and the second peripheral wire 35 are provided. By forming, on the undercoat layer, a photosensitive layer for forming the first conductive portion 32, the first peripheral wire 33, the second conductive portion 34, and the second peripheral wire 35, the adhesion of the first conductive portion 32, the first peripheral wire 33, the second conductive portion 34, and the second peripheral wire 35 to the transparent base 30 is further improved.

The method of forming an undercoat layer is not particularly limited. Examples thereof include a method including: applying an undercoat layer forming composition including a polymer to a substrate; and performing a heating treatment as necessary. The undercoat layer forming composition may include a solvent as necessary. The kind of the solvent is not particularly limited, and examples of the solvent include a solvent which is used in a photosensitive layer forming composition to be described later. A latex including fine particles of a polymer may be used as the undercoat layer forming composition including a polymer.

The thickness of the undercoat layer is not particularly limited. The thickness is preferably 0.02 to 0.3 μm, and more preferably 0.03 to 0.2 μm in view of more excellent adhesion of the first conductive portion 32, the first peripheral wire 33, the second conductive portion 34, and the second peripheral wire 35 to the transparent base 30.

<Thin Metallic Wire>

The thin metallic wire 36 has electroconductivity and is made of, for example, a metal or an alloy. The thin metallic wire 36 can be formed of, for example, a copper wire or a silver wire. The thin metallic wire 36 preferably includes metallic silver, and may include metals other than the metallic silver, such as gold and copper. In addition, the thin metallic wire 36 preferably contains a polymer binder such as metallic silver and gelatin suitable for the formation of the mesh pattern.

The thin metallic wire 36 is not limited to a thin metallic wire made of a metal or an alloy as described above. The thin metallic wire may include, for example, metal oxide particles, a metal paste such as a silver paste or a copper paste, and metal nanowire particles such as a silver nanowire or a copper nanowire.

Next, a method of forming a thin metallic wire 36 will be described. The method of forming a thin metallic wire 36 is not particularly limited as long as it can be formed on the transparent bases 30 and 31. As the method of forming a thin metallic wire 36, for example, a plating method, a silver salt method, a vapor deposition method, a printing method, or the like can be properly used.

A method of forming a thin metallic wire 36 through a plating method will be described. For example, the thin metallic wire 36 can be formed of a metal plating film which is formed on a base layer by performing electroless plating on the electroless plating base layer. In this case, a catalyst ink containing at least fine metal particles is formed in a pattern on a base material, and then the base material is dipped in an electroless plating bath to form a metal plating film. More specifically, a method of manufacturing a metal-coated base material described in JP2014-159620A can be used. In addition, a resin composition having at least a functional group capable of interacting with a metal catalyst precursor is formed in a pattern on a base material, and then a catalyst or a catalytic precursor is applied and the base material is dipped in an electroless plating bath to form a metal plating film. More specifically, a method of manufacturing a metal-coated base material described in JP2012-144761A can be applied.

A method of forming a thin metallic wire 36 through a silver salt method will be described. First, an exposure treatment is performed using an exposure pattern to be the thin metallic wire 36, and then a development treatment is performed. Thus, the thin metallic wire 36 can be formed. More specifically, a method of manufacturing a thin metallic wire described in JP2015-22397A can be used.

A method of forming a thin metallic wire 36 through a vapor deposition method will be described. First, a copper foil layer is formed by vapor deposition, and a copper wire is formed from the copper foil layer through a photolithographic method. Thus, the thin metallic wire 36 can be formed. As the copper foil layer, electrolytic copper foil can be used other than deposition copper foil. More specifically, a step of forming a copper wire described in JP2014-29614A can be used.

A method of forming a thin metallic wire 36 through a printing method will be described. First, a conductive paste containing a conductive powder is applied to a substrate in the same pattern as the thin metallic wire 36, and then a heating treatment is performed thereon. Thus, the thin metallic wire 36 can be formed. The pattern formation using a conductive paste is performed through, for example, an inkjet method or a screen printing method. As the conductive paste, more specifically, a conductive paste described in JP2011-28985A can be used.

Next, the first conductive portion 32 and the second conductive portion 34 will be described.

The first conductive portion 32 has a first wiring pattern in which a plurality of first openings of congruent convex pentagons constituted by thin metallic wires 36 are arranged. The first wiring pattern is formed of congruent convex pentagons. The second conductive portion 34 has a second wiring pattern in which a plurality of openings constituted by thin metallic wires 36 are provided. The second wiring pattern has an objection to the first wiring pattern. The second wiring pattern is determined so as to be a pattern with a coefficient of variation of less than 52% specified by the first wiring pattern in a case where the first wiring pattern is determined.

The smaller the coefficient of variation, the better the noise visibility. The lower limit value of the coefficient of variation is 0%. Hereinafter, the congruent convex pentagon is also called a convex pentagon.

In the first conductive portion 32 and the second conductive portion 34, when viewed in the direction Dn (see FIGS. 4 and 5) vertical to the front surface 10a of the conductive film 10, that is, the front surface 30a of the transparent base 30, that is, in the lamination direction D3 (see FIGS. 4 and 5) in which the first conductive portion 32 and the second conductive portion 34 overlap each other, the coefficient of variation of the opening area is less than 52% in the opening group formed by the first wiring pattern of the first conductive portion 32 and the second wiring pattern of the second conductive portion 34.

In a case where a plane filling pattern using a congruent convex pentagon is used as the wiring pattern and the coefficient of variation is less than 52%, the wiring pattern is formed of mesh cells with a constant opening ratio, differently from a random pattern, and thus the generation of noise components can be reduced in it as compared to a random pattern. In addition, regarding interference of the congruent convex pentagon and the square or triangle grid black matrix of a liquid crystal display cell or the like of a liquid crystal display device, the interference hardly occurs, and thus moire hardly occurs. Therefore, in a case where a display object of the display unit 22 is viewed in a state in which the conductive film 10 is disposed on the display unit 22 as described above, the suppression of the occurrence of moire and the suppression of the occurrence of noise can be balanced. Moreover, in the plane filling pattern using a congruent convex pentagon, the thin metallic wires 36 have low regularity, and thus the occurrence of gloss from the thin metallic wire 36 in a continuous range is also suppressed. The recognition of a display image of the display unit 22 is not hindered by gloss of the thin metallic wire 36 caused by incidence rays at a specific angle.

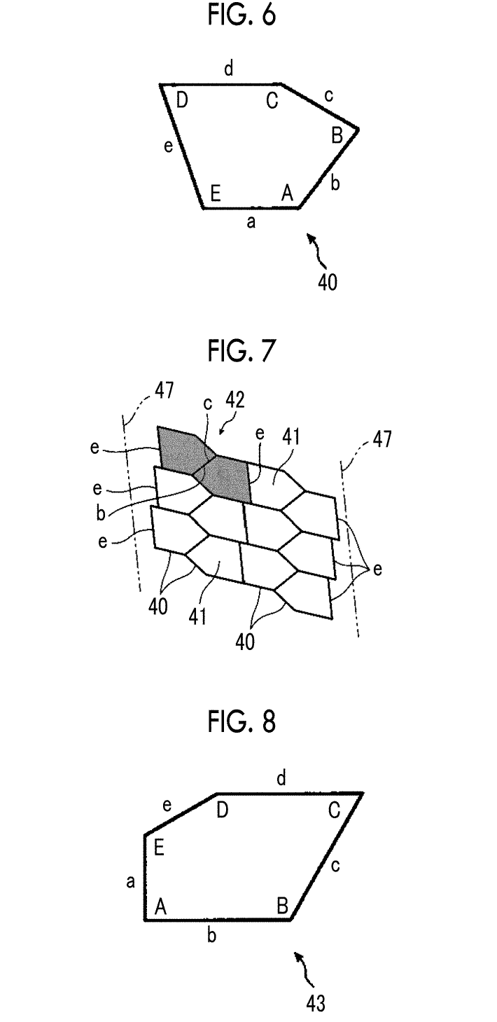

Next, the convex pentagon and the first wiring pattern of the first conductive portion 32 will be described based on FIGS. 6 to 37.

15 kinds of convex pentagons capable of filling a plane are known. That is, 15 kinds of convex pentagons capable of forming a wiring pattern on the plane are known. Among these, 14 kinds are shown in “Analysis of Marcia P Sward Lobby Tiling”, Bulletin of the Society for Science on Form, Vol. 26, 2 (2011), p. 122 to 131, TERUHISA SUGIMOTO.

The convex pentagon refers to, among pentagons, a pentagon in which a line segment connecting arbitrary two points in the pentagon is always included in the pentagon.

Hereinafter, the convex pentagon will be described with references a to e indicating five sides, respectively, and references A to E indicating five angles, respectively. The convex pentagon has a side a, a side b, a side c, a side d, and a side e. In the pentagon, an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

A convex pentagon 40 illustrated in FIG. 6 is referred to as type 01 stan. The convex pentagon 40 satisfies angle A+angle B+angle C=180° and is characterized in that a side e is not disposed on a straight line. A first wiring pattern 42 illustrated in FIG. 7 is formed of a plurality of congruent convex pentagons 40, and has a plurality of openings 41 of the convex pentagons 40. Sides b of the plurality of convex pentagons 40 and sides c of the plurality of convex pentagons 40 are matched, and sides e of the plurality of convex pentagons 40 are disposed by changing a predetermined distance from a straight line 47. That is, the sides e of the plurality of convex pentagons are not disposed on the same straight line, so that the plurality of convex pentagons 40 are disposed with the deviated sides e.

Regarding the plurality of congruent convex pentagons 40, the sides b of the convex pentagons 40 and the sides c of the convex pentagons 40 are matched, and the sides e are disposed on a straight line. This case is referred to as type 01 edge.

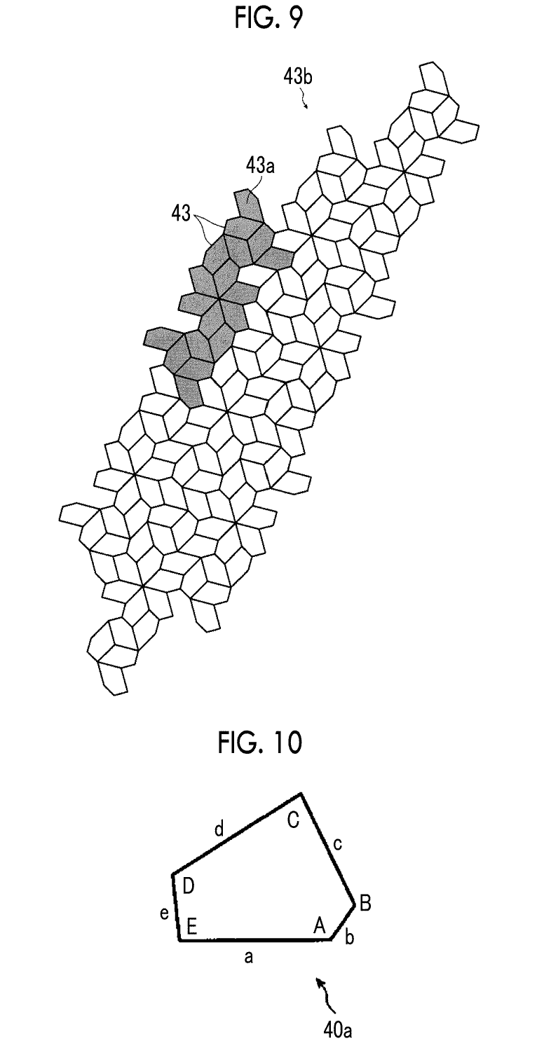

A convex pentagon 43 illustrated in FIG. 8 is referred to as type 01 sp. The convex pentagon 43 satisfies angle A=90°, angle B=angle E=120°, angle C=60°, angle D=150°, side a=side e, and side b=side c=side d. A first wiring pattern 43b illustrated in FIG. 9 is formed of a plurality of congruent convex pentagons 43, and has a plurality of openings 43a of the convex pentagons 43.

A basic repeating unit 43c constituting the first wiring pattern 43b illustrated in FIG. 9 includes the arrangement of convex pentagons 43 including a site where three convex pentagons 43 are in contact with each other at an apex B of each convex pentagon 43, that is, an intersection of a side b with a side c, and a site where six convex pentagons 43 are in contact with each other at an apex C of each convex pentagon 43, that is, an intersection of a side c with a side d.

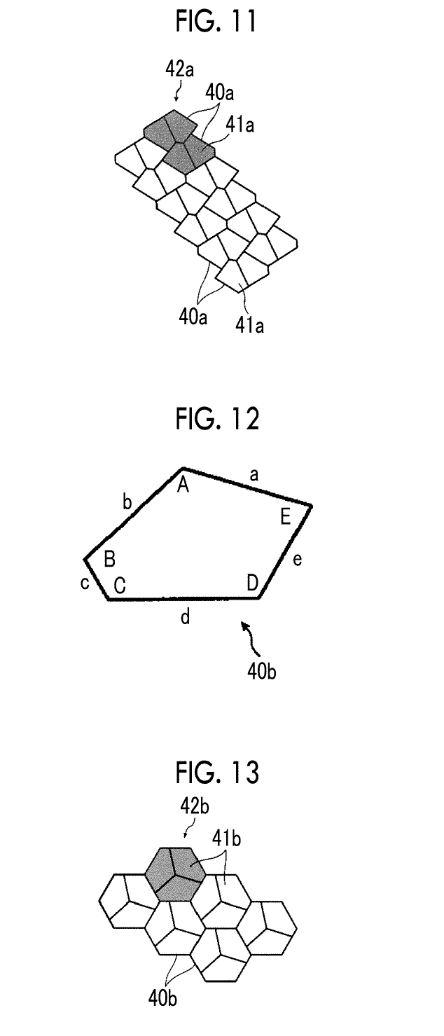

A convex pentagon 40a illustrated in FIG. 10 is referred to as type 02. The convex pentagon 40a satisfies angle A+angle B+angle D=180° and side a=side d. A first wiring pattern 42a illustrated in FIG. 11 is formed of a plurality of congruent convex pentagons 40a, and has a plurality of openings 41a of the convex pentagons 40a.

A convex pentagon 40b illustrated in FIG. 12 is referred to as type 03. The convex pentagon 40b satisfies angle A+angle C+angle D=120°, side a=side b, and side d=side c+side e. A first wiring pattern 42b illustrated in FIG. 13 is formed of a plurality of congruent convex pentagons 40b, and has a plurality of openings 41b of the convex pentagons 40b.

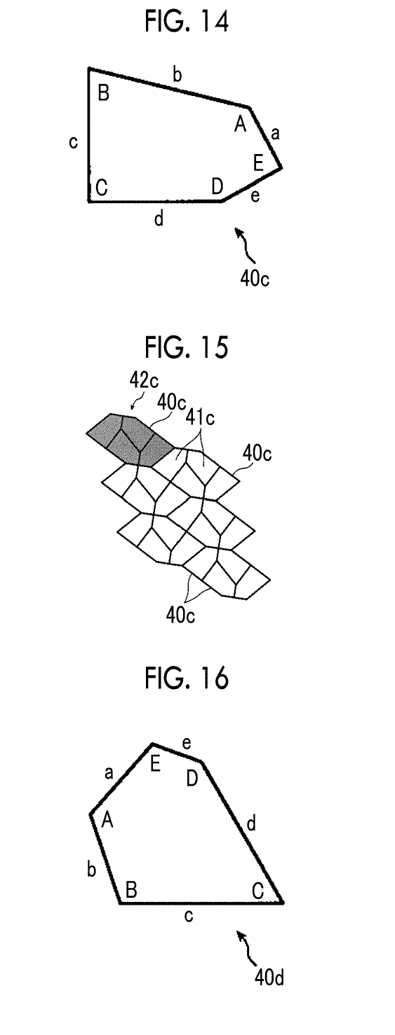

A convex pentagon 40c illustrated in FIG. 14 is referred to as type 04. The convex pentagon 40c satisfies angle C=angle E=90°, side a=side e, and side c=side d. A first wiring pattern 42c illustrated in FIG. 15 is formed of a plurality of congruent convex pentagons 40c, and has a plurality of openings 41c of the convex pentagons 40c.

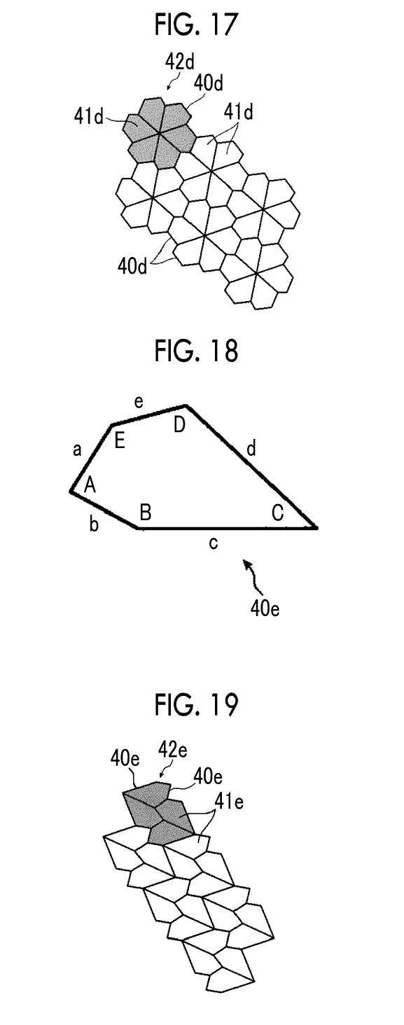

A convex pentagon 40d illustrated in FIG. 16 is referred to as type 05. The convex pentagon 40d satisfies angle A=120°, angle C=60°, side a=side b, and side c=side d. A first wiring pattern 42d illustrated in FIG. 17 is formed of a plurality of congruent convex pentagons 40d, and has a plurality of openings 41d of the convex pentagons 40d.

A convex pentagon 40e illustrated in FIG. 18 is referred to as type 06. The convex pentagon 40e satisfies angle A+angle B+angle D=360°, angle A=angle C×2, side a=side b=side e, and side c=side d. A first wiring pattern 42e illustrated in FIG. 19 is formed of a plurality of congruent convex pentagons 40e, and has a plurality of openings 41e of the convex pentagons 40e.

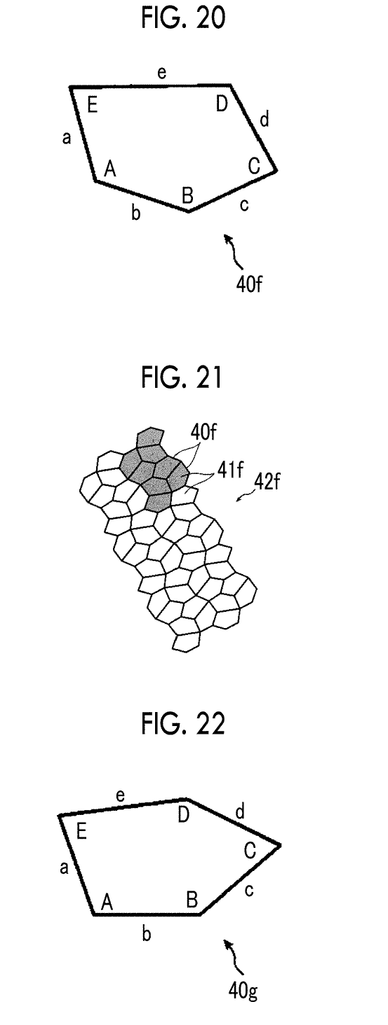

A convex pentagon 40f illustrated in FIG. 20 is referred to as type 07. The convex pentagon 40f satisfies angle B×2+angle C=360°, angle D×2+angle A=360°, and side a=side b=side c=side d. A first wiring pattern 42f illustrated in FIG. 21 is formed of a plurality of congruent convex pentagons 40f, and has a plurality of openings 41f of the convex pentagons 40f.

A convex pentagon 40g illustrated in FIG. 22 is referred to as type 08. The convex pentagon 40g satisfies angle A×2+angle B=360°, angle D×2+angle C=360°, and side a=side b=side c=side d. A first wiring pattern 42g illustrated in FIG. 23 is formed of a plurality of congruent convex pentagons 40g, and has a plurality of openings 41g of the convex pentagons 40g.

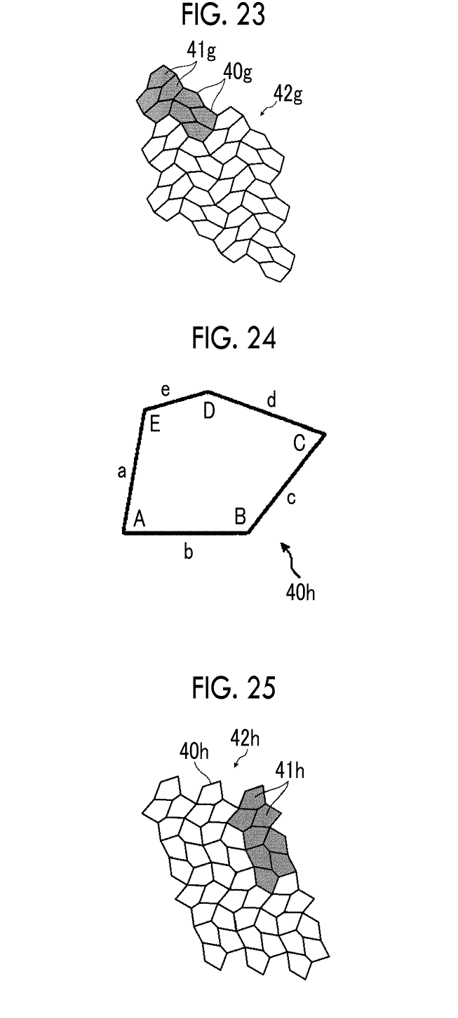

A convex pentagon 40h illustrated in FIG. 24 is referred to as type 09. The convex pentagon 40h satisfies angle E×2+angle B=360°, angle D×2+angle C=360°, and side a=side b=side c=side d. A first wiring pattern 42h illustrated in FIG. 25 is formed of a plurality of congruent convex pentagons 40h, and has a plurality of openings 41h of the convex pentagons 40h.

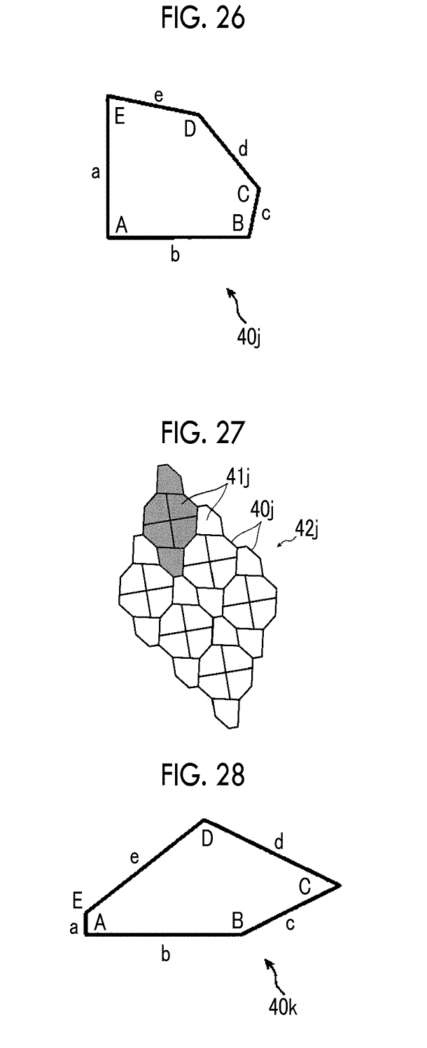

A convex pentagon 40j illustrated in FIG. 26 is referred to as type 10. The convex pentagon 40j satisfies angle A=90°, angle B+angle E=180°, angle D×2+angle E=360°, angle C×2+angle B=360°, and side a=side b=(side c+side e). A first wiring pattern 42j illustrated in FIG. 27 is formed of a plurality of congruent convex pentagons 40j, and has a plurality of openings 41j of the convex pentagons 40j.

A convex pentagon 40k illustrated in FIG. 28 is referred to as type 11. The convex pentagon 40k satisfies angle A=90°, angle C+angle E=180°, angle B×2+angle C=360°, and side d=side e=(side a×2+side c). A first wiring pattern 42k illustrated in FIG. 29 is formed of a plurality of congruent convex pentagons 40k, and has a plurality of openings 41k of the convex pentagons 40k.

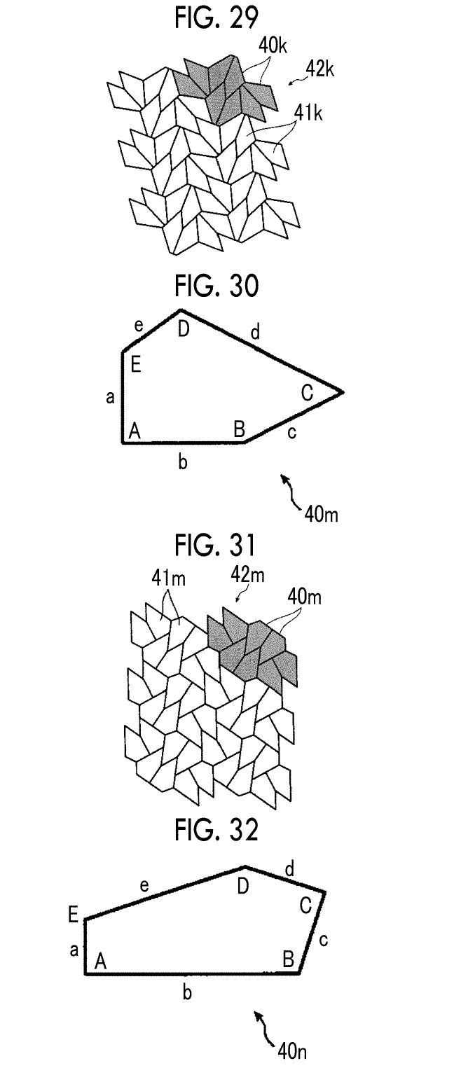

A convex pentagon 40m illustrated in FIG. 30 is referred to as type 12. The convex pentagon 40m satisfies angle A=90°, angle C+angle E=180°, angle B×2+angle C=360°, and side a×2=side d=(side c+side e). A first wiring pattern 42m illustrated in FIG. 31 is formed of a plurality of congruent convex pentagons 40m, and has a plurality of openings 41m of the convex pentagons 40m.

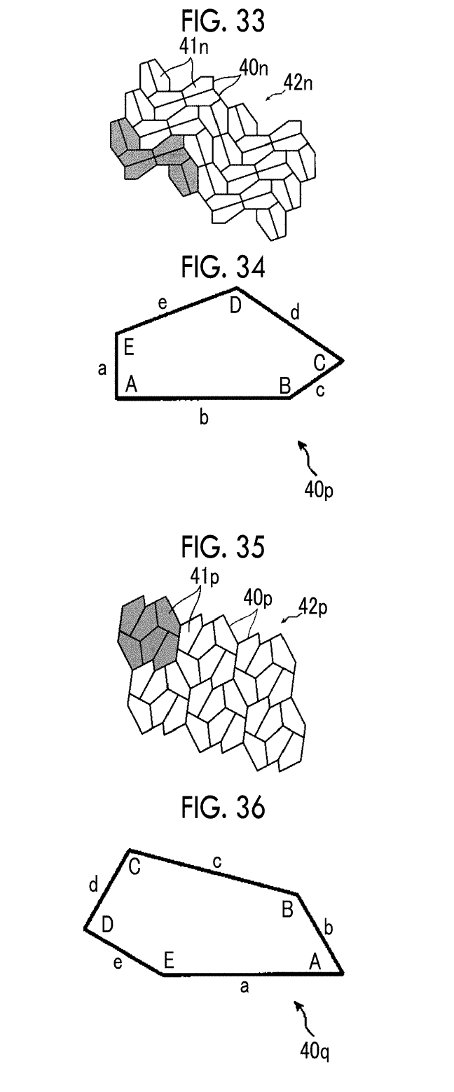

A convex pentagon 40n illustrated in FIG. 32 is referred to as type 13. The convex pentagon 40n satisfies angle A=angle C=90°, angle B×2=angle E×2=(360°−angle D), and side c×2=side d×2=side e. A first wiring pattern 42n illustrated in FIG. 33 is formed of a plurality of congruent convex pentagons 40n, and has a plurality of openings 41n of the convex pentagons 40n.

A convex pentagon 40p illustrated in FIG. 34 is referred to as type 14. The convex pentagon 40p satisfies angle A=90°, angle B=145.34°, angle C=69.32°, angle D=124.66°, angle E=110.68°, and side a×2=side c×2=side d=side e. A first wiring pattern 42p illustrated in FIG. 35 is formed of a plurality of congruent convex pentagons 40p, and has a plurality of openings 41p of the convex pentagons 40p.

A convex pentagon 40q illustrated in FIG. 36 is referred to as type 15. The convex pentagon 40q satisfies angle A=90°, angle B=135°, angle C=105°, angle D=90°, angle E=150°, side a=1, side b=½, side c=1/(2(√3−1))^{1/2}, side d=½, and side e=½. A first wiring pattern 42q illustrated in FIG. 37 is formed of a plurality of congruent convex pentagons 40q, and has a plurality of openings 41q of the convex pentagons 40q.

All of the above-described convex pentagons have a straight-line side, but the side may be formed of a wavy line. In a case where the side is a wavy line, it may be a sine wave-like side or an arc-like side.

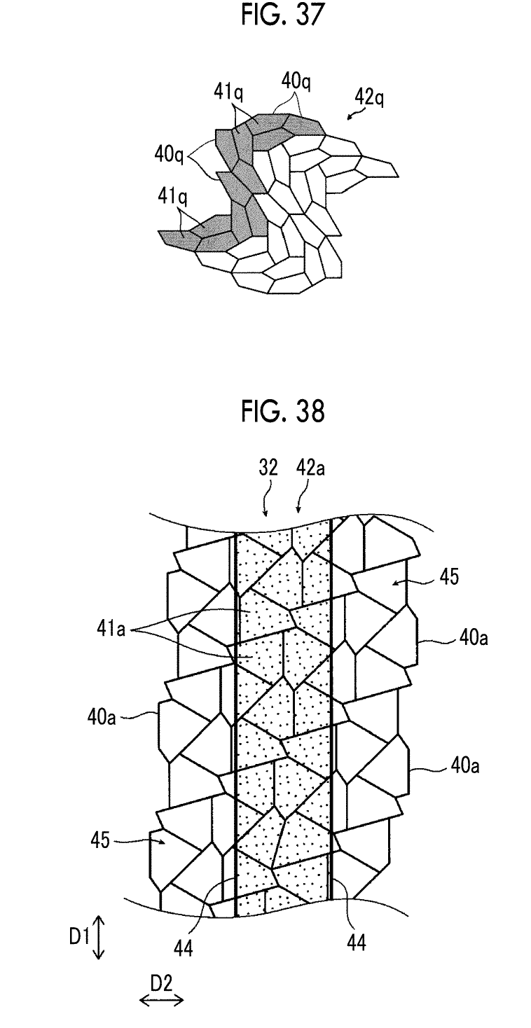

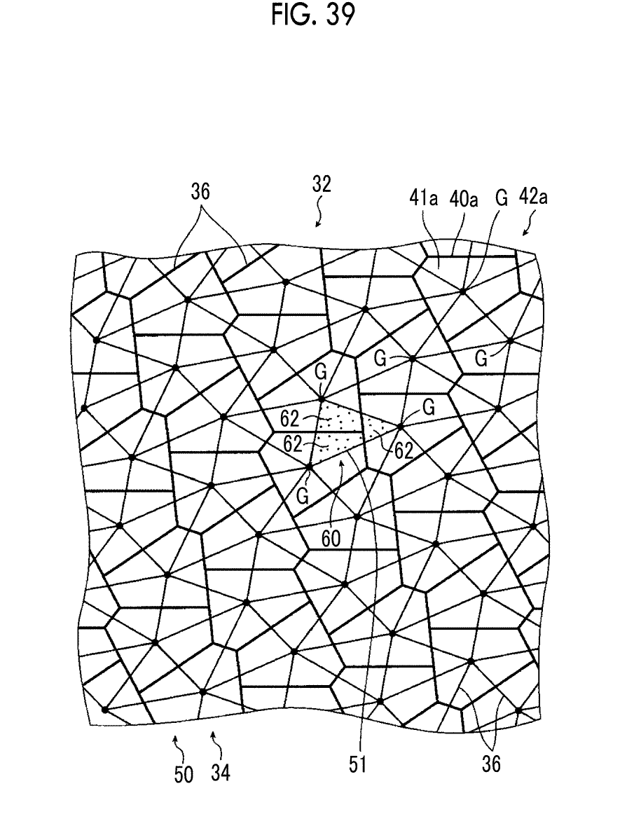

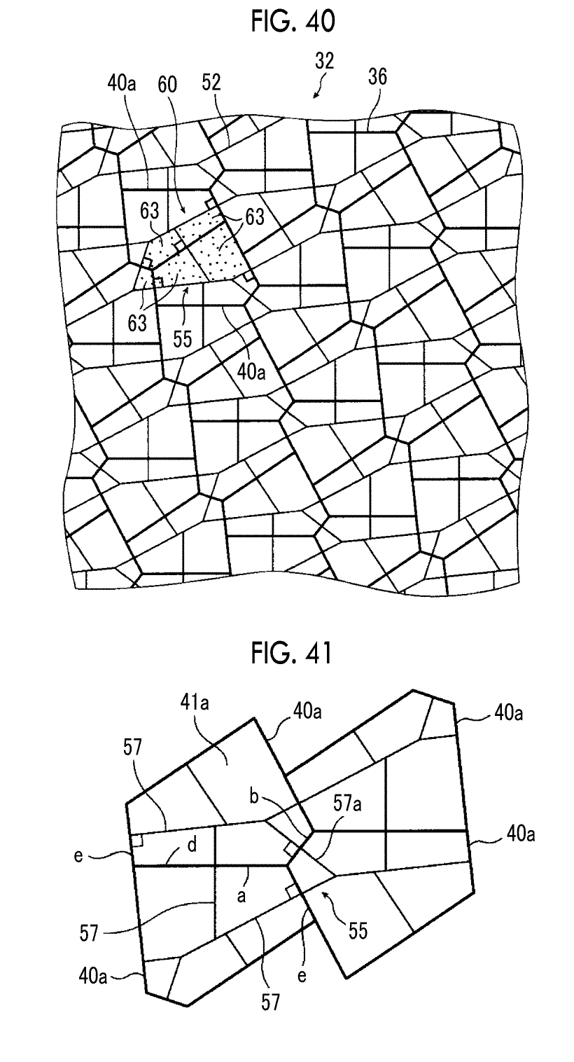

FIG. 38 is a schematic diagram illustrating an example of the first wiring pattern of the conductive film according to an embodiment of the invention. A first direction D1 and a second direction D2 of FIG. 38 correspond to the first direction D1 and the second direction D2 of FIG. 3.

As illustrated in FIG. 38, a plurality of congruent convex pentagons 40a, in which planes are filled, are disposed, and convex pentagons 40a are cut by straight line-like visible outlines 44 shown by thick lines. The convex pentagons 40a cut by the visible outlines 44 are electrically insulated from other convex pentagons 40a. The region sandwiched between the visible outlines 44 is a first conductive portion 32, and a plurality of congruent convex pentagons 40a forms a first wiring pattern 42a in which a plurality of first openings 41a of the convex pentagons 40a are arranged.

A region 45 other than the first conductive portion 32 may be eliminated. In a case where the region is not eliminated, it may be divided into small pieces. From the viewpoint of the transmittance, it is preferable that the region is not eliminated, but serves as a dummy wire. The visible outline 44 is not limited to the straight line, and may be a sawtooth wave-like line.

Next, the second wiring pattern of the second conductive portion 34 will be described.

FIG. 39 is a schematic diagram illustrating a first example of the second wiring pattern of the conductive film according to an embodiment of the invention. In FIG. 39, a first wiring pattern 42a and a second wiring pattern 50 are illustrated, and a state viewed in the direction Dn (not shown, see FIGS. 4 and 5) vertical to the front surface 30a (not shown, see FIGS. 4 and 5) of the transparent base 30 (not shown, see FIGS. 4 and 5), that is, in the lamination direction D3 (see FIGS. 4 and 5) in which the first conductive portion 32 and the second conductive portion 34 overlap each other is illustrated. The first wiring pattern 42a is formed of convex pentagons 40a as described above.

In an opening group 60 formed by the first wiring pattern 42a of the first conductive portion 32 and the second wiring pattern 50 of the second conductive portion 34 as illustrated in FIG. 39, the coefficient of variation of the opening area is less than 52%. Accordingly, the occurrence of moire and noise can be reduced regardless of the resolution of a display device. Furthermore, the recognition of a display image of the display unit 22 (see FIG. 1) is not hindered by gloss of the thin metallic wire 36 caused by incidence rays at a specific angle.

Regarding the second wiring pattern 50 of the second conductive portion 34, it is necessary to adjust the coefficient of variation of the opening area to less than 52% with the first wiring pattern 42a as described above, and thus the second wiring pattern depends on the first wiring pattern 42a. For example, as illustrated in FIG. 39, the second wiring pattern 50 is provided with a plurality of polygonal openings 51 having an apex at a center of gravity G of the first opening 41a of the first wiring pattern 42a.

Next, the coefficient of variation will be described.

The coefficient of variation is referred to as a relative standard deviation. The coefficient of variation is a value indicating the standard deviation of the areas of the openings by percentages based on the average value of the areas of the openings.

In a case where two wiring patterns with rhombus openings overlap each other as in FIG. 76 to be described later, the coefficient of variation is 0% in theory. That is, there is no variation in the area of the opening formed by two rhombuses.

In FIG. 39, an opening group 60 formed of one opening 51 and a plurality of congruent convex pentagons 40a is illustrated as an example. In the opening 51, a convex pentagon 40a forms an opening 62. The variation in the area of each opening 62 is expressed as a coefficient of variation.

The areas of the openings 62 are obtained, and using the obtained areas of the openings 62, the coefficient of variation is obtained. Regarding the area of the opening 62, a photograph is taken in the direction Dn (not shown, see FIGS. 4 and 5) vertical to the front surface 30a (not shown, see FIGS. 4 and 5) of the transparent base 30 (not shown, see FIGS. 4 and 5), that is, in the lamination direction D3 (see FIGS. 4 and 5) in which the first conductive portion 32 and the second conductive portion 34 overlap each other, and the photographic data is input to a personal computer to obtain the number of pixels of the opening 62. The result is converted into the area. The standard deviation of the areas of the openings 62 and the average value of the areas of the openings 62 are obtained, and from these, a coefficient of variation is obtained.

FIG. 40 is a schematic diagram illustrating a second example of the second wiring pattern of the conductive film according to an embodiment of the invention. FIG. 41 is a schematic diagram for explaining the second wiring pattern. In FIG. 40, a first wiring pattern 42a and a second wiring pattern 50 are illustrated, and a state viewed in the direction Dn (not shown, see FIGS. 4 and 5) vertical to the front surface 30a (not shown, see FIGS. 4 and 5) of the transparent base 30 (not shown, see FIGS. 4 and 5), that is, in the lamination direction D3 (see FIGS. 4 and 5) in which the first conductive portion 32 and the second conductive portion 34 overlap each other is illustrated.

For example, as illustrated in FIG. 40, an opening 53 of the second wiring pattern 52 has a polygonal shape. A perpendicular bisector of each side of a first opening 41b of the first wiring pattern 42a constitutes at least one of three sides of the opening 53 of the second wiring pattern 52.

In FIG. 40, an opening group 60 formed of one opening 55 and a plurality of congruent convex pentagons 40a is illustrated as an example. In the opening 55, a convex pentagon 40a forms an opening 63. The variation in the area of each opening 63 is expressed as a coefficient of variation. The method of obtaining a coefficient of variation is the same as that in the above-described example of FIG. 39.

In a state in which four convex pentagons 40a are collected as illustrated in FIG. 41, the opening 55 has a quadrangular shape. Four sides of the opening 55 are constituted by perpendicular bisectors. Specifically, the opening 55 is formed by a perpendicular bisector 57a of a side b, a perpendicular bisector 57b of a side e, a perpendicular bisector 57c of a side d, and a perpendicular bisector 57d of a side e.

In a case where the opening 53 of the second wiring pattern 52 is not a two-dimensional figure closed only by perpendicular bisectors 57 of the convex pentagon, but at least one side of the opening 53 of the second wiring pattern 52 is constituted by a perpendicular bisector 57 of the convex pentagon, other sides can be arbitrarily set such that the coefficient of variation is less than 52%.

In FIG. 40, an opening group 60 formed of one opening 53 and a plurality of congruent convex pentagons 40a is illustrated as an example. In the opening 53, a convex pentagon 40a forms an opening 63. The variation in the area of each opening 63 is expressed as a coefficient of variation.

The areas of the openings 63 are obtained, and using the obtained areas of the openings 63, the coefficient of variation is obtained. The method of obtaining the area of the opening 63 is the same as the above-described method of obtaining the area of the opening 62.

The second wiring pattern 52 has been described using the congruent convex pentagon 40a as an example, but the second wiring pattern can be obtained with any one of the above-described convex pentagons through the above-described two kinds of methods.

In the opening group 60 formed by the first wiring pattern 42a and the second wiring pattern 50 illustrated in FIGS. 40 and 41, the coefficient of variation of the opening area is less than 52%. In this case also, the occurrence of moire and noise can be reduced regardless of the resolution of a display device. Furthermore, the recognition of a display image of the display unit 22 (see FIG. 1) is not hindered by gloss of the thin metallic wire 36 caused by incidence rays at a specific angle.

Next, specific examples of the first wiring pattern of the first conductive portion 32 and the second wiring pattern of the second conductive portion will be illustrated in FIGS. 42 to 75. In FIGS. 42 to 75, the same constituent materials as those in FIGS. 6 to 37 are denoted by the same references, and detailed description thereof is omitted.

FIGS. 42 to 75 illustrate a state viewed in the direction Dn (not shown, see FIGS. 4 and 5) vertical to the front surface 30a (not shown, see FIGS. 4 and 5) of the transparent base 30 (not shown, see FIGS. 4 and 5), that is, in the lamination direction D3 (see FIGS. 4 and 5) in which the first conductive portion 32 and the second conductive portion 34 overlap each other.

Among FIGS. 42 to 75, even-numbered figures illustrate a second wiring pattern having openings having an apex at a center of gravity G of the convex pentagon, and among FIGS. 42 to 75, odd-numbered figures illustrate that at least one side of an opening is a perpendicular bisector of a side of the convex pentagon.

In all cases of FIGS. 42 to 75, as described above, the occurrence of moire and noise can be reduced regardless of the resolution of a display unit in a case where the conductive film is disposed on the display unit. Furthermore, the recognition of a display image of the display unit 22 (see FIG. 1) is not hindered by gloss of the thin metallic wire 36 caused by incidence rays at a specific angle.

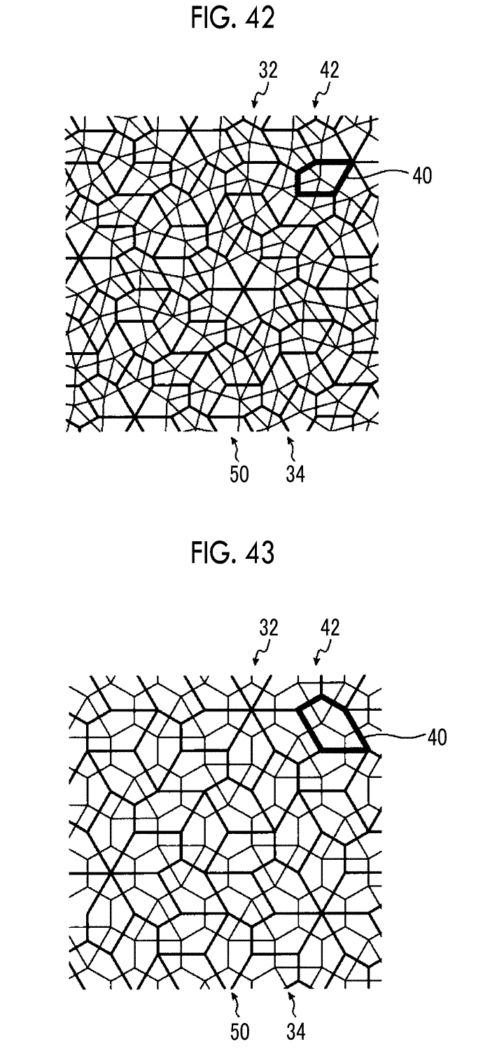

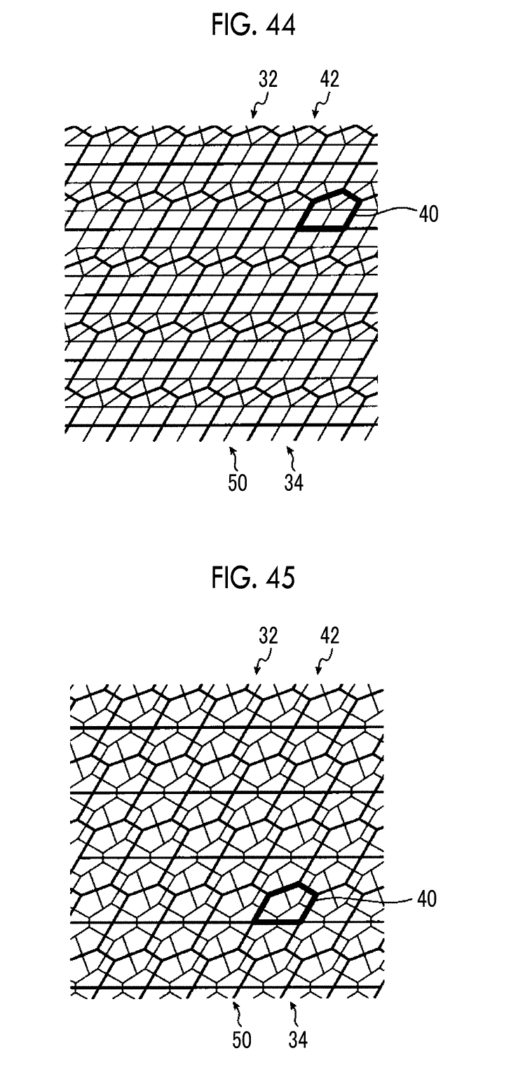

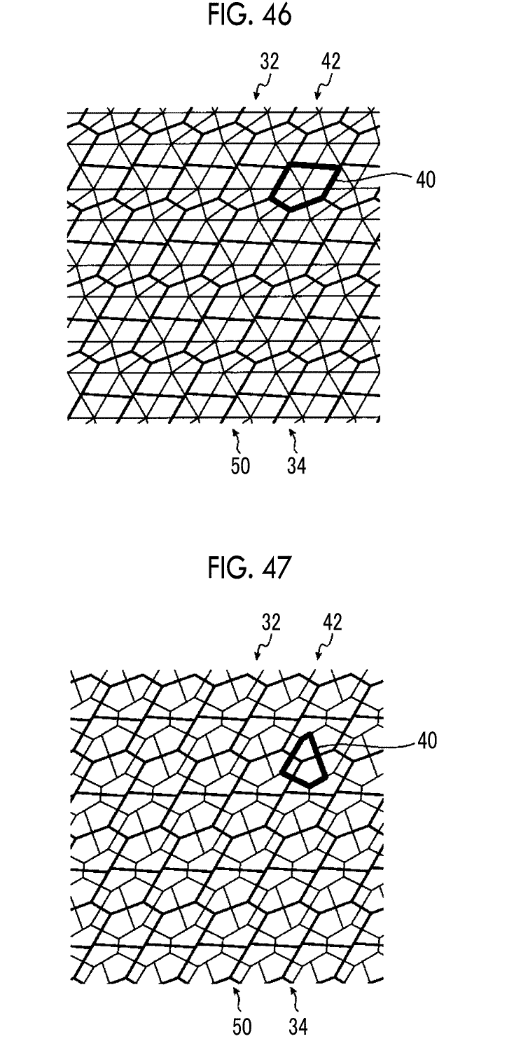

In FIGS. 42 to 47, the convex pentagon 40 illustrated in FIG. 6 is used. The first wiring pattern of FIGS. 42 and 43 is also referred to as type 01 sp. The first wiring pattern of FIGS. 44 and 45 is also referred to as type 01 edge. The first wiring pattern of FIGS. 46 and 47 is also referred to as type 01 stan.

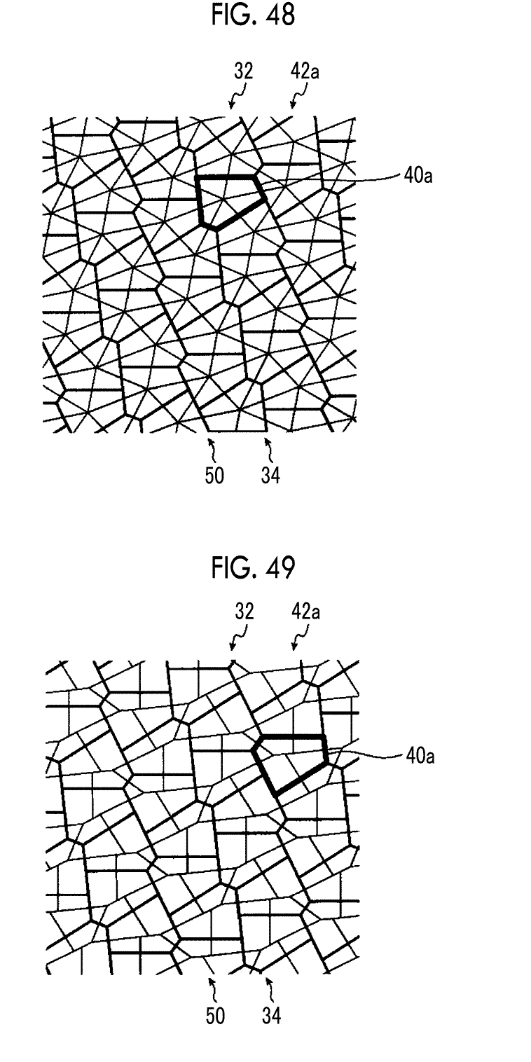

In FIGS. 48 and 49, the convex pentagon 40a illustrated in FIG. 10 is used, and the first wiring pattern is also referred to as type 02. FIG. 48 is the same as FIG. 39, and FIG. 49 is the same as FIG. 40.

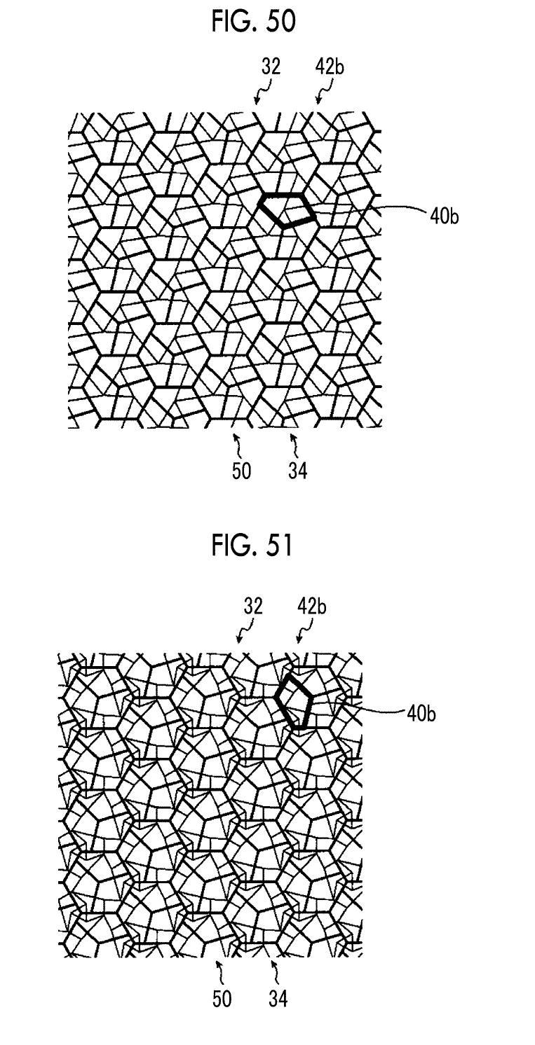

In FIGS. 50 and 51, the convex pentagon 40b illustrated in FIG. 12 is used, and the first wiring pattern is also referred to as type 03.

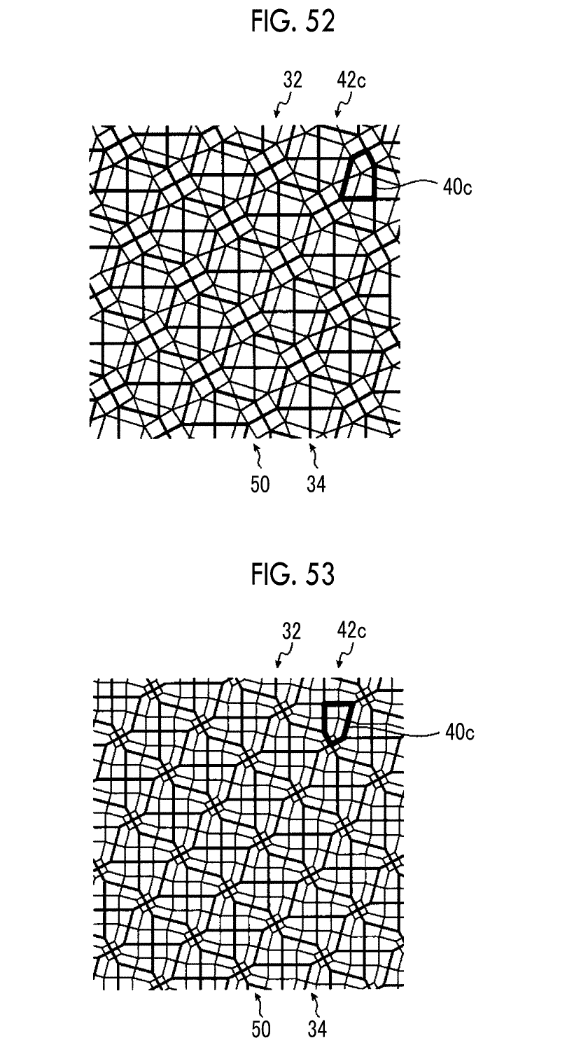

In FIGS. 52 and 53, the convex pentagon 40c illustrated in FIG. 14 is used, and the first wiring pattern is also referred to as type 04.

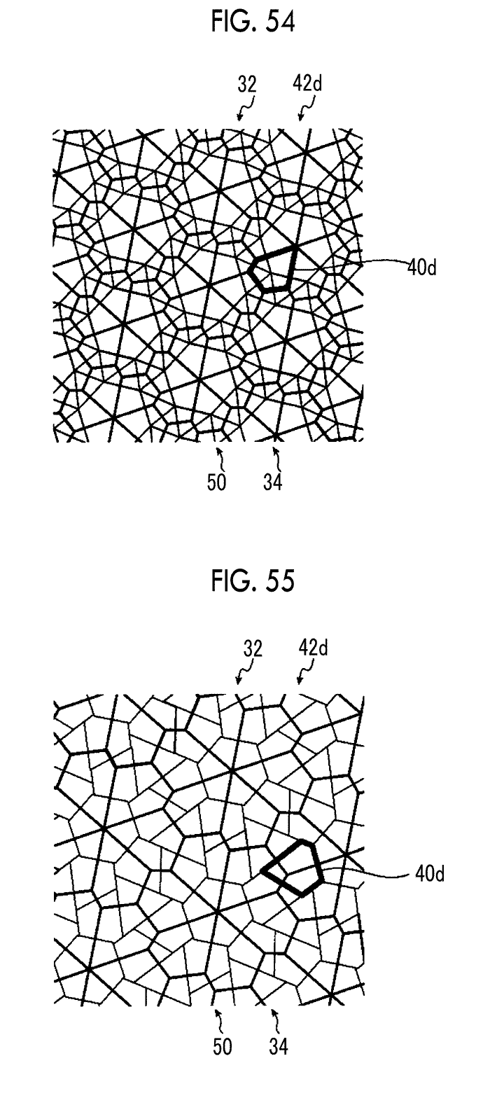

In FIGS. 54 and 55, the convex pentagon 40d illustrated in FIG. 16 is used, and the first wiring pattern is also referred to as type 05.

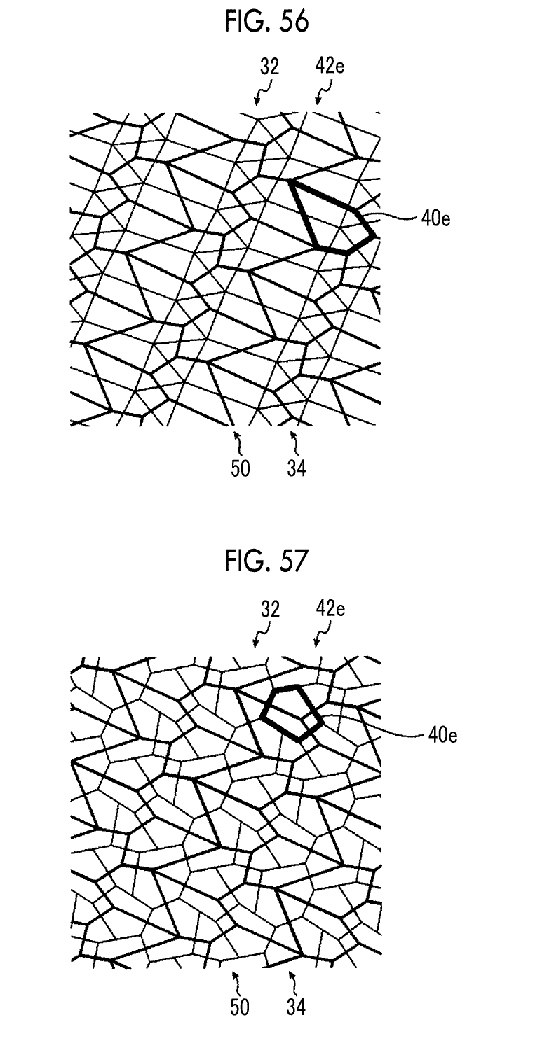

In FIGS. 56 and 57, the convex pentagon 40e illustrated in FIG. 18 is used, and the first wiring pattern is also referred to as type 06.

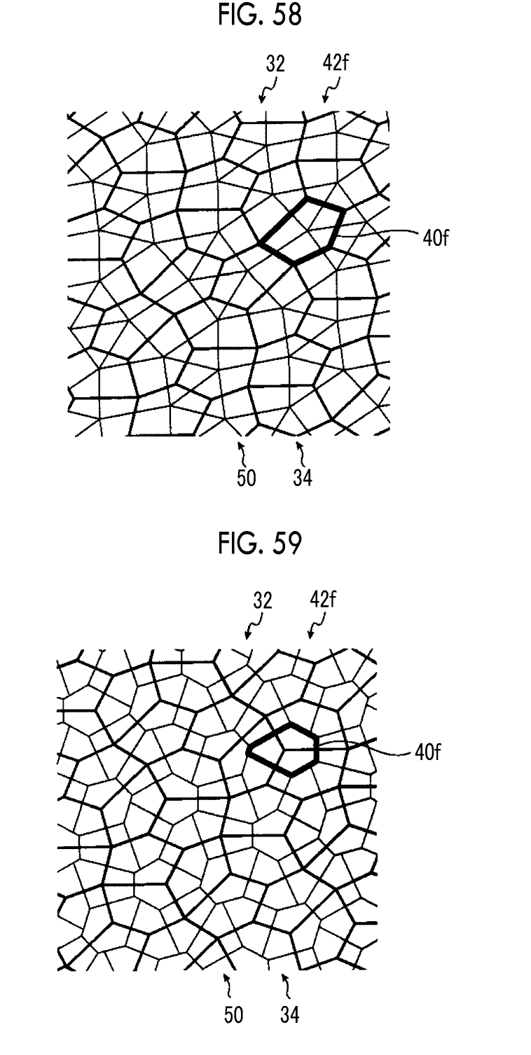

In FIGS. 58 and 59, the convex pentagon 40f illustrated in FIG. 20 is used, and the first wiring pattern is also referred to as type 07.

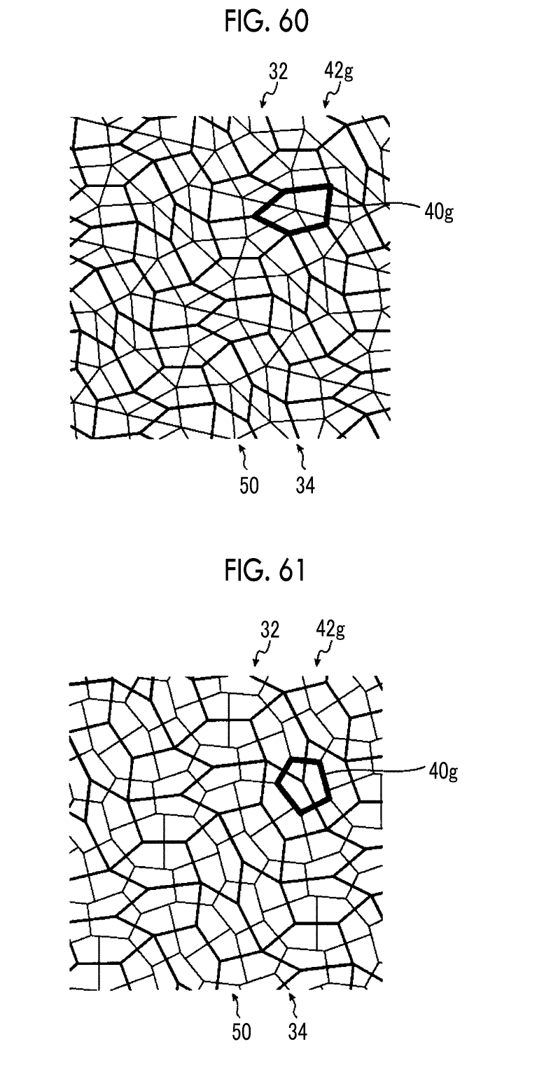

In FIGS. 60 and 61, the convex pentagon 40g illustrated in FIG. 22 is used, and the first wiring pattern is also referred to as type 08.

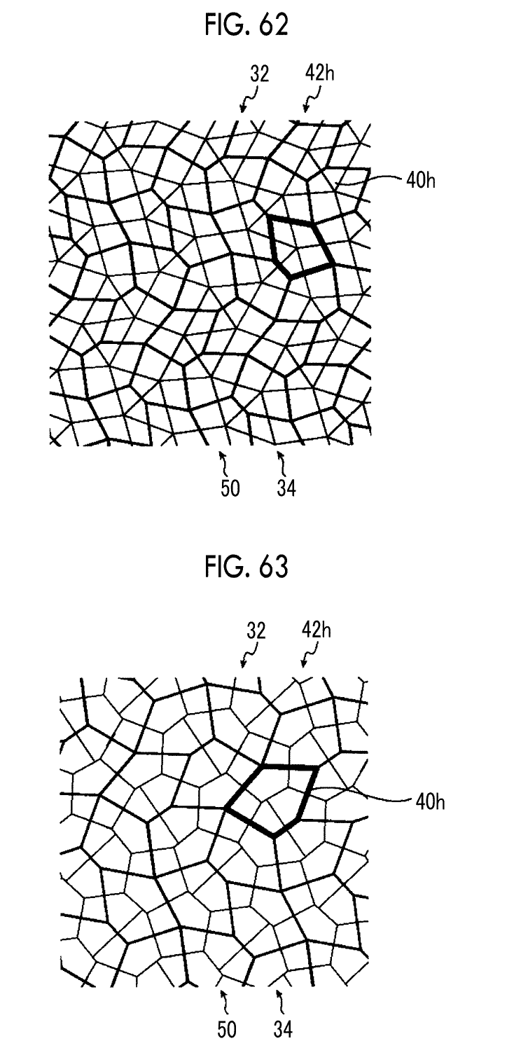

In FIGS. 62 and 63, the convex pentagon 40h illustrated in FIG. 24 is used, and the first wiring pattern is also referred to as type 09.

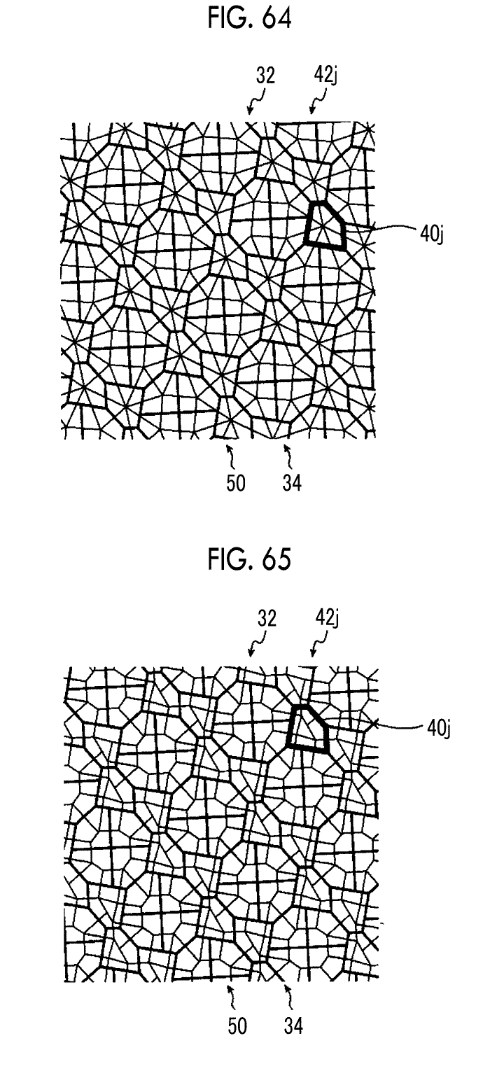

In FIGS. 64 and 65, the convex pentagon 40j illustrated in FIG. 26 is used, and the first wiring pattern is also referred to as type 10.

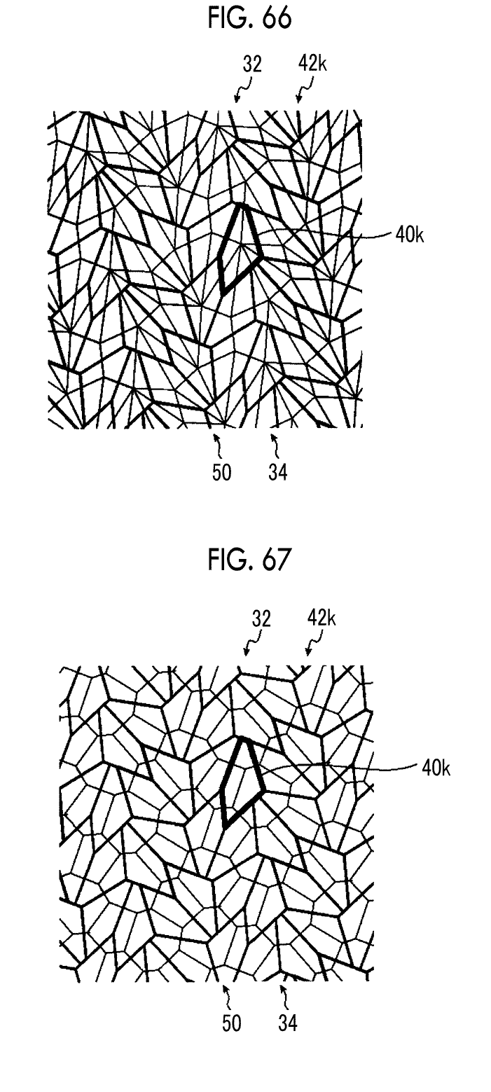

In FIGS. 66 and 67, the convex pentagon 40k illustrated in FIG. 28 is used, and the first wiring pattern is also referred to as type 11.

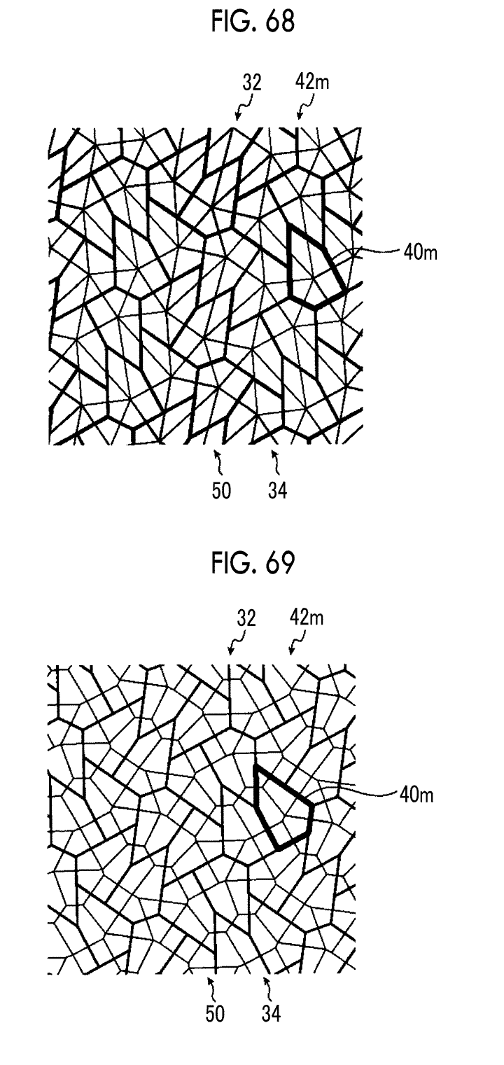

In FIGS. 68 and 69, the convex pentagon 40m illustrated in FIG. 30 is used, and the first wiring pattern is also referred to as type 12.

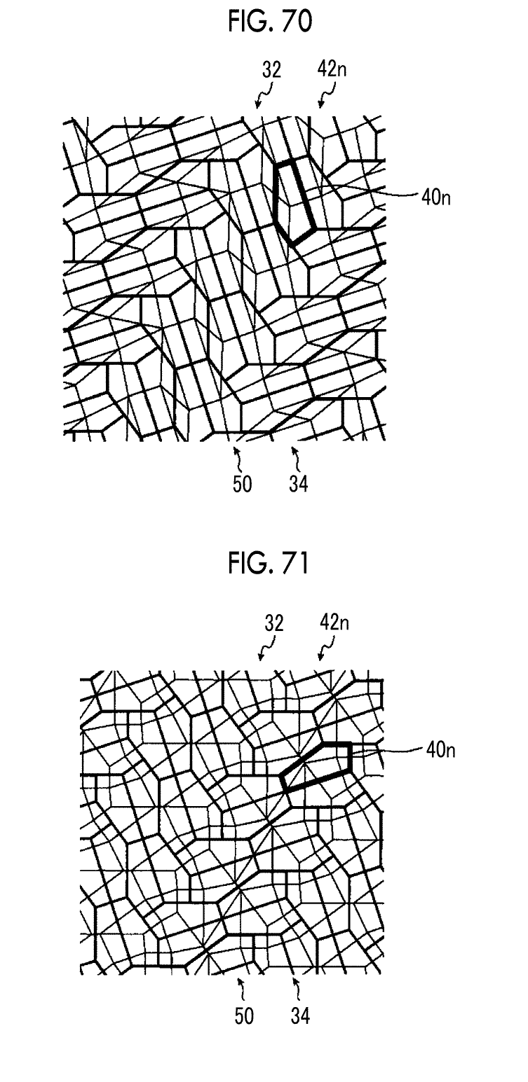

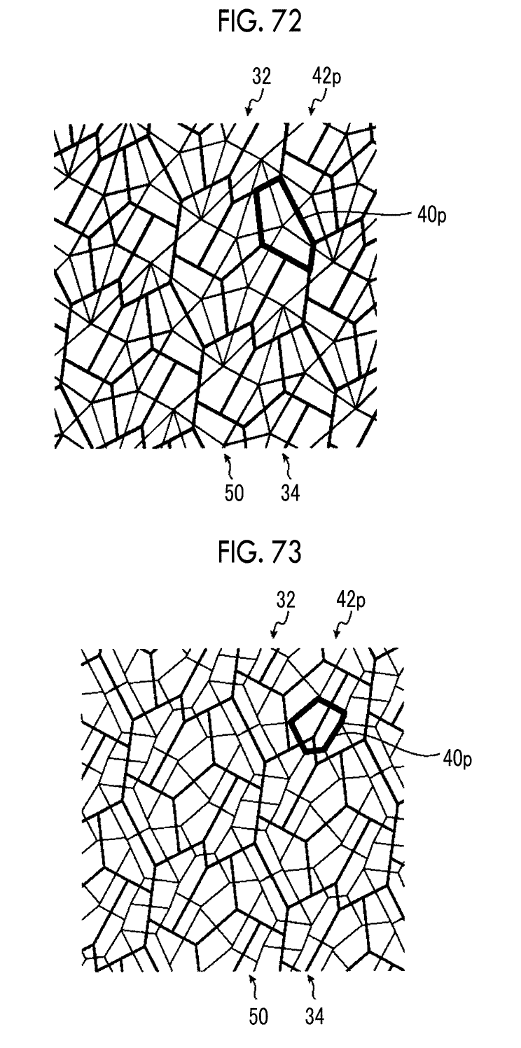

In FIGS. 70 and 71, the convex pentagon 40n illustrated in FIG. 32 is used, and the first wiring pattern is also referred to as type 13.

In FIGS. 72 and 73, the convex pentagon 40p illustrated in FIG. 34 is used, and the first wiring pattern is also referred to as type 14.

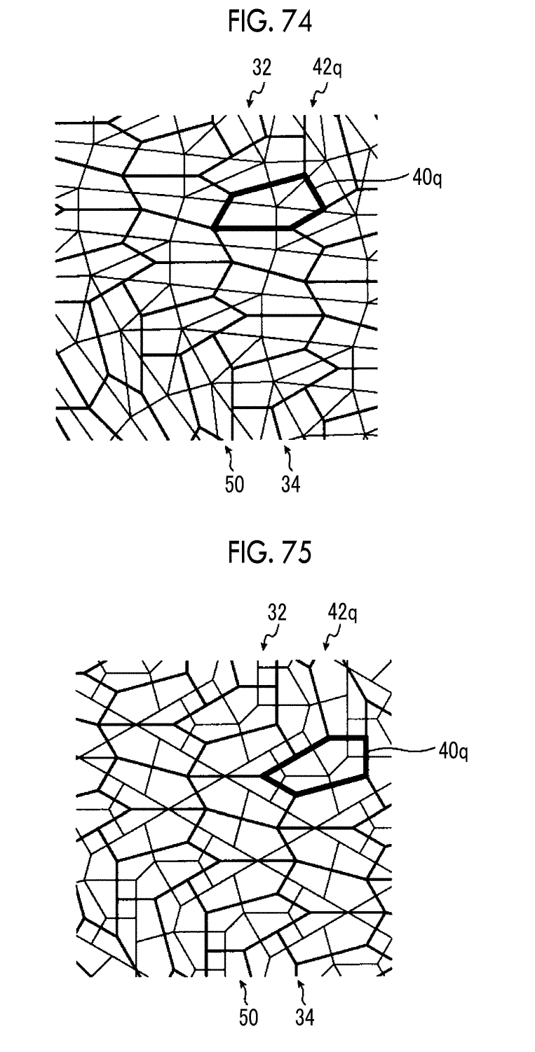

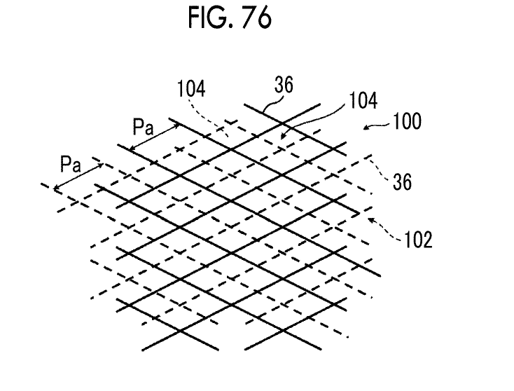

In FIGS. 74 and 75, the convex pentagon 40q illustrated in FIG. 36 is used, and the first wiring pattern is also referred to as type 15.

Basically, the invention is constituted as above. The conductive film and the touch panel according to the invention have been described in detail, but the invention is not limited to the above-described embodiments. Needless to say, various modifications or changes may be made without departing from the gist of the invention.

### EXAMPLES

Hereinafter, characteristics of the invention will be described in more detail with examples. The materials, reagents, amounts, substance amounts, ratios, treatment contents, treatment procedures, and the like shown in the following examples can be properly changed without departing from the intent of the invention. Accordingly, the scope of the invention is not restrictively interpreted by the following specific examples.

In the examples, conductive films having wiring patterns illustrated in FIGS. 42 to 75 and FIG. 76, respectively, were formed, and using a touch panel provided with the conductive film, model versatility, moire visibility, noise visibility, and gloss visibility were evaluated. The evaluation results are shown in the following Table 1.

<Production of Touch Panel for Evaluation>

A liquid crystal display device (hereinafter, referred to as a liquid crystal display (LCD)), an optically transparent pressure sensitive adhesive (OCA, optical clear adhesive, manufactured by 3M, 8146-3 (product No.)), a produced conductive film, an optically transparent pressure sensitive adhesive (OCA, optical clear adhesive, manufactured by 3M, 8146-3 (product No.)), and cover glass were laminated in this order to produce display equipment. As the liquid crystal display device, devices having resolutions of 100 dpi (dots per inch), 150 dpi, 200 dpi, 250 dpi, 300 dpi, and 350 dpi, respectively, were used, and display equipment was produced as described above.

<Evaluation of Model Versatility, Moire Visibility, and Noise Visibility>

In the display equipment, the LCD displays only a green image on the screen, and the screen display is observed at various angles. Ten testers performed the same observation to evaluate the moire visibility and the noise visibility based on the following standards.

The conductive film installation angle was adjusted, and an installation angle at which the most excellent moire visibility and noise visibility (neither moire nor noise was visually recognized) were provided was searched to determine a conductive film installation angle common to the LCDs of 100 dpi to 350 dpi. This operation was performed when a touch panel for evaluation was produced.

The LCDs of the respective resolutions were observed, and in a case where preferable results were simultaneously obtained in the evaluation of the moire visibility and the noise visibility, that is, the evaluation results were A or B, the model versatility was evaluated to be A. In a case where preferable results were not simultaneously obtained, the model versatility was evaluated to be D.

The moire visibility and the noise visibility were evaluated to be one of A to D based on the following evaluation standards from statistics of the results of the observation by ten testers.

Number of People Who Visually Recognized Moire or Noise

A: 0

B: 1 or 2

C: 3 to 6

D: 7 to 10

The evaluation result A represents that there are no problems, the evaluation result B represents acceptable moire or noise, the evaluation result C represents unacceptable moire or noise, and the evaluation result D represents clearly unacceptable moire or noise. It is preferable that the evaluation result is A or B.

<Evaluation of Gloss Visibility>

In the display equipment, the LCD displays only a green image on the screen, and the screen display is observed at various angles. Ten testers performed the same observation, and the gloss visibility was evaluated to be one of A to D based on the following evaluation standards.

Number of People Who Visually Recognized Wide Range of Gloss

A: 0

B: 1 or 2

C: 3 to 6

D: 7 to 10

The evaluation result A represents that there are no problems, the evaluation result B represents acceptable gloss, the evaluation result C represents unacceptable gloss, and the evaluation result D represents clearly unacceptable gloss. It is preferable that the evaluation result is A or B.

Hereinafter, a method of producing a conductive film 10 will be described.

<Method of Producing Conductive Film>

(Preparation of Silver Halide Emulsion)

To the following liquid 1 kept at 38° C. and pH 4.5, the following liquids 2 and 3 were added for 20 minutes simultaneously with stirring of 90% of the liquid 2 and 90% of the liquid 3, and thus nuclear particles of 0.16 μm were formed. Next, the following liquids 4 and 5 were added for 8 minutes, and the remaining 10% of the following liquid 2 and the remaining 10% of the following liquid 3 were added for 2 minutes to grow the particles to 0.21 μm. 0.15 g of potassium iodide was further added, aging was performed for 5 minutes, and the formation of the particles was terminated.

Liquid 1:

| | | |
|---|---|---|
| Water | 750 | ml |
| Gelatin | 9 | g |
| Sodium Chloride | 3 | g |
| 1,3-Dimethylimidazolidine-2-Thione | 20 | mg |
| Sodium Benzenethiolsulfonate | 10 | mg |
| Citric Acid | 0.7 | g |

Liquid 2:

| | |
|---|---|
| Water | 300 ml |
| Silver Nitrate | 150 g |

Liquid 3:

| | | |
|---|---|---|
| Water | 300 | ml |
| Sodium Chloride | 38 | g |
| Potassium Bromide | 32 | g |
| Potassium Hexachloroiridate (III) | 8 | ml |
| (0.005% KCl, 20% aqueous solution) | | |
| Ammonium Hexachlorinated Rhodiumate | 10 | ml |
| (0.001% NaCl, 20% aqueous solution) | | |

Liquid 4:

| | |
|---|---|
| Water | 100 ml |
| Silver Nitrate | 50 g |

Liquid 5:

| | |
|---|---|
| Water | 100 ml |
| Sodium Chloride | 13 g |
| Potassium Bromide | 11 g |
| Yellow Prussiate of Potash | 5 mg |

Then, water washing was performed in the usual manner by a flocculation method. Specifically, the temperature was reduced to 35° C., and using a sulfuric acid, the pH was reduced (pH 3.6±0.2) until the silver halide was precipitated. Next, about 3 L of the supernatant liquid was removed (first water washing). 3 L of distilled water was further added, and then a sulfuric acid was added until the silver halide was precipitated. 3 L of the supernatant liquid was removed once again (second water washing). The same operation as the second water washing was repeated one time (third water washing), and the water washing and desalting step was terminated. The emulsion after the water washing and desalting was adjusted to pH 6.4 and pAg 7.5. 3.9 g of gelatin, 10 mg of sodium benzenethiolsulfonate, 3 mg of sodium benzenethiosulfinate, 15 mg of sodium thiosulfate, and 10 mg of a chlorauric acid were added to conduct chemical sensitization so as to obtain optimum sensitivity at 55° C., and 100 mg of 1,3,3a,7-tetraazaindene as a stabilizer and 100 mg of PROXEL (trade name, manufactured by ICI Co., Ltd.) as a preservative were added. The finally obtained emulsion was a cubic silver iodochlorobromide particle emulsion containing 0.08 mol % of silver iodide, containing 70 mol % of silver chloride and 30 mol % of silver bromide in terms of silver chlorobromide ratio, and having an average particle size of 0.22 μm and a coefficient of variation of 9%.

(Preparation of Photosensitive Layer Forming Composition)

1.2×10⁻⁴ mol/mol Ag of 1,3,3a,7-tetraazaindene, 1.2×10⁻² mol/mol Ag of hydroquinone, 3.0×10⁻⁴ mol/mol Ag of a citric acid, 0.90 g/mol Ag of 2,4-dichloro-6-hydroxy-1,3,5-triazine sodium salt, and a small amount of a hardening agent were added to the above-described emulsion, and the pH of the liquid to be applied was adjusted to 5.6 using a citric acid.

To the above-described liquid to be applied, a polymer represented by (P-1) and a polymer latex (mass ratio of dispersant/polymer: 2.0/100=0.02) containing a dispersant consisting of dialkylphenyl PEO sulfate were added such that the ratio (mass ratio) of polymer/gelatin contained was 0.5/1.

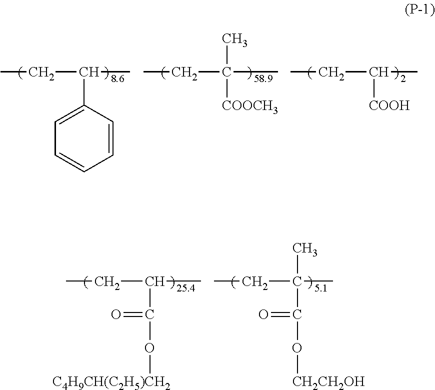

EPDXY RESIN DY 022 (trade name: manufactured by Nagase ChemteX Corporation) was further added as a crosslinking agent. The amount of the crosslinking agent to be added was adjusted such that the amount of the crosslinking agent in a photosensitive layer to be described later was 0.09 g/m².

In this manner, a photosensitive layer forming composition was prepared.

The above-described polymer represented by (P-1) was synthesized with reference to JP3305459B and JP3754745B.

(Photosensitive Layer Forming Step)

The above-described polymer latex was applied to both surfaces of a transparent base 30 to provide an undercoat layer having a thickness of 0.05 μm. A polyethylene terephthalate (PET) film (manufactured by FUJIFILM Corporation) of 100 μm was used as the transparent base 30.

Next, an antihalation layer formed of a mixture of the above-described polymer latex, gelatin, and a dye, which has an optical density of about 1.0 and is decolored by an alkali in a developer, was provided on the undercoat layer. The mixing mass ratio of the polymer to gelatin (polymer/gelatin) was 2/1, and the content of the polymer was 0.65 g/m².

The above-described photosensitive layer forming composition was applied to the above-described antihalation layer, and a composition obtained by mixing the above-described polymer latex, gelatin, EPOCROS K-2020E (trade name: manufactured by NIPPON SHOKUBAI CO., LTD., oxazoline-based crosslinking reactive polymer latex (crosslinking group: oxazoline group)), and SNOWTEX C (trade name: manufactured by NISSAN CHEMICAL INDUSTRIES. LTD., colloidal silica) such that the solid content mass ratio (polymer/gelatin/EPOCROS K-2020E/SNOWTEX C) was 1/1/0.3/2 was further applied such that the gelatin amount was 0.08 g/m². Thus, a support in which a photosensitive layer was formed on both surfaces was obtained. The support in which a photosensitive layer was formed on both surfaces is set as a film A. In the formed photosensitive layer, the silver amount was 6.2 g/m², and the gelatin amount was 1.0 g/m².

(Exposure Development Step)

Photo masks having the above-described wiring patterns illustrated in FIGS. 42 to 75 and FIG. 76, respectively, were prepared. A photo mask having a wiring pattern illustrated in one of FIGS. 42 to 75 and FIG. 76 was disposed on both surfaces of the above-described film A, and exposure was performed using parallel light from a high-pressure mercury lamp as a light source.

After the exposure, development was performed using the following developer, and a fixer (trade name: N3X-R for CN16X, manufactured by FUJIFILM Corporation) was further used to perform the development treatment. Furthermore, rinsing with pure water and drying were performed, and thus a support in which a functional pattern composed of thin Ag (silver) wires, a pattern for thickness adjustment composed of thin Ag wires, and a gelatin layer were formed on both surfaces was obtained. The gelatin layer was formed between the thin Ag wires. The obtained film is set as a film B.

(Composition of Developer)

The following compounds are contained in 1 L of a developer 1.

| | |
|---|---|
| Hydroquinone | 0.037 mol/L |
| N-Methylaminophenol | 0.016 mol/L |
| Sodium Metaborate | 0.140 mol/L |
| Sodium Hydroxide | 0.360 mol/L |
| Sodium Bromide | 0.031 mol/L |
| Potassium Metabisulfite | 0.187 mol/L |

(Gelatin Decomposition Treatment)

The film B was dipped for 120 seconds in an aqueous solution (concentration of proteolytic enzyme: 0.5 mass %, liquid temperature: 40° C.) of proteolytic enzyme (BIOPRASE AL-15FG manufactured by Nagase ChemteX Corporation). The film B was taken out of the aqueous solution, and dipped for 120 seconds in warm water (liquid temperature: 50° C.) for washing. The film after the gelatin decomposition treatment is set as a film C.

(Resistance Reducing Treatment)

A calendaring treatment was performed with a pressure of 30 kN on the above-described film C using a calendaring device formed of a metal roller. In this case, two PET films having a roughened surface shape with line roughness Ra of 0.2 μm and Sm of 1.9 μm (measured by a shape analysis laser microscope VK-X110 manufactured by KEYENCE CORPORATION (JIS-B-0601-1994)) were transported together such that the roughened surfaces thereof faced a front surface and a rear surface of the above-described film C, and the roughened surface shape was transferred and formed on the front surface and the rear surface of the above-described film C.

After the above-described calendaring treatment, a heating treatment was performed by passing for 120 seconds through a superheated steam tank at a temperature of 150° C. The film after the heating treatment is set as a film D. The film D is a conductive film.

Next, Examples 1 to 37 and Comparative Examples 1 to 10 will be described.

Conductive films of Examples 1 to 37 and Comparative Examples 1 to 10 were produced as shown in the following Table 1. The wire width of a thin metallic wire was adjusted by adjusting a width of a pattern corresponding to the thin metallic wires in an exposure mask, an exposure amount, an exposure wavelength, a developer, a development time, and a development temperature condition so as to obtain a predetermined wire width. The exposure amount includes exposure illuminance and exposure time.

### Example 1

Example 1 was a conductive film having a wiring pattern illustrated in FIG. 44. The wire width of a thin metallic wire was 3.0 μm, and the opening ratio was 98.0%.

### Example 2

Example 2 was a conductive film having a wiring pattern illustrated in FIG. 46. The wire width of a thin metallic wire was 3.0 μm, and the opening ratio was 98.0%.

### Example 3

Example 3 was a conductive film having a wiring pattern illustrated in FIG. 48. The wire width of a thin metallic wire was 3.0 μm, and the opening ratio was 98.0%.

### Example 4

Example 4 was a conductive film having a wiring pattern illustrated in FIG. 50. The wire width of a thin metallic wire was 3.0 μm, and the opening ratio was 98.0%.

### Example 5

Example 5 was a conductive film having a wiring pattern illustrated in FIG. 52. The wire width of a thin metallic wire was 3.0 μm, and the opening ratio was 98.0%.

### Example 6

Example 6 was a conductive film having a wiring pattern illustrated in FIG. 58. The wire width of a thin metallic wire was 3.0 μm, and the opening ratio was 98.0%.

### Example 7

Example 7 was a conductive film having a wiring pattern illustrated in FIG. 60. The wire width of a thin metallic wire was 3.0 μm, and the opening ratio was 98.0%.

### Example 8

Example 8 was a conductive film having a wiring pattern illustrated in FIG. 62. The wire width of a thin metallic wire was 3.0 μm, and the opening ratio was 98.0%.

### Example 9

Example 9 was a conductive film having a wiring pattern illustrated in FIG. 64. The wire width of a thin metallic wire was 3.0 μm, and the opening ratio was 98.0%.

### Example 10

Example 10 was a conductive film having a wiring pattern illustrated in FIG. 66. The wire width of a thin metallic wire was 3.0 μm, and the opening ratio was 98.0%.

### Example 11

Example 11 was a conductive film having a wiring pattern illustrated in FIG. 68. The wire width of a thin metallic wire was 3.0 μm, and the opening ratio was 98.0%.

### Example 12

Example 12 was a conductive film having a wiring pattern illustrated in FIG. 70. The wire width of a thin metallic wire was 3.0 μm, and the opening ratio was 98.0%.

### Example 13

Example 13 was a conductive film having a wiring pattern illustrated in FIG. 74. The wire width of a thin metallic wire was 3.0 μm, and the opening ratio was 98.0%.

### Example 14

Example 14 was a conductive film having a wiring pattern illustrated in FIG. 45. The wire width of a thin metallic wire was 3.0 μm, and the opening ratio was 98.0%.

### Example 15

Example 15 was a conductive film having a wiring pattern illustrated in FIG. 43. The wire width of a thin metallic wire was 3.0 μm, and the opening ratio was 98.0%.

### Example 16

Example 16 was a conductive film having a wiring pattern illustrated in FIG. 47. The wire width of a thin metallic wire was 3.0 μm, and the opening ratio was 98.0%.

### Example 17

Example 17 was a conductive film having a wiring pattern illustrated in FIG. 49. The wire width of a thin metallic wire was 3.0 μm, and the opening ratio was 98.0%.

### Example 18

Example 18 was a conductive film having a wiring pattern illustrated in FIG. 53. The wire width of a thin metallic wire was 3.0 μm, and the opening ratio was 98.0%.

### Example 19

Example 19 was a conductive film having a wiring pattern illustrated in FIG. 55. The wire width of a thin metallic wire was 3.0 μm, and the opening ratio was 98.0%.

### Example 20

Example 20 was a conductive film having a wiring pattern illustrated in FIG. 57. The wire width of a thin metallic wire was 3.0 μm, and the opening ratio was 98.0%.

### Example 21

Example 21 was a conductive film having a wiring pattern illustrated in FIG. 59. The wire width of a thin metallic wire was 3.0 μm, and the opening ratio was 98.0%.

### Example 22

Example 22 was a conductive film having a wiring pattern illustrated in FIG. 61. The wire width of a thin metallic wire was 3.0 μm, and the opening ratio was 98.0%.

### Example 23

Example 23 was a conductive film having a wiring pattern illustrated in FIG. 63. The wire width of a thin metallic wire was 3.0 μm, and the opening ratio was 98.0%.

### Example 24

Example 24 was a conductive film having a wiring pattern illustrated in FIG. 65. The wire width of a thin metallic wire was 3.0 μm, and the opening ratio was 98.0%.

### Example 25

Example 25 was a conductive film having a wiring pattern illustrated in FIG. 67. The wire width of a thin metallic wire was 3.0 μm, and the opening ratio was 98.0%.

### Example 26

Example 26 was a conductive film having a wiring pattern illustrated in FIG. 69. The wire width of a thin metallic wire was 3.0 μm, and the opening ratio was 98.0%.

### Example 27

Example 27 was a conductive film having a wiring pattern illustrated in FIG. 73. The wire width of a thin metallic wire was 3.0 μm, and the opening ratio was 98.0%.

### Example 28

Example 28 was a conductive film having a wiring pattern illustrated in FIG. 48. The wire width of a thin metallic wire was 2.5 μm, and the opening ratio was 98.3%.

### Example 29

Example 29 was a conductive film having a wiring pattern illustrated in FIG. 48. The wire width of a thin metallic wire was 2.0 μm, and the opening ratio was 98.7%.

### Example 30

Example 30 was a conductive film having a wiring pattern illustrated in FIG. 48. The wire width of a thin metallic wire was 1.5 μm, and the opening ratio was 99.0%.

### Example 31

Example 31 was a conductive film having a wiring pattern illustrated in FIG. 48. The wire width of a thin metallic wire was 1.0 μm, and the opening ratio was 99.3%.

### Example 32

Example 32 was a conductive film having a wiring pattern illustrated in FIG. 48. The wire width of a thin metallic wire was 0.5 μm, and the opening ratio was 99.7%.

### Example 33

Example 33 was a conductive film having a wiring pattern illustrated in FIG. 49. The wire width of a thin metallic wire was 2.5 μm, and the opening ratio was 98.3%.

### Example 34

Example 34 was a conductive film having a wiring pattern illustrated in FIG. 49. The wire width of a thin metallic wire was 2.0 μm, and the opening ratio was 98.7%.

### Example 35

Example 35 was a conductive film having a wiring pattern illustrated in FIG. 49. The wire width of a thin metallic wire was 1.5 μm, and the opening ratio was 99.0%.

### Example 36

Example 36 was a conductive film having a wiring pattern illustrated in FIG. 49. The wire width of a thin metallic wire was 1.0 μm, and the opening ratio was 99.3%.

### Example 37

Example 37 was a conductive film having a wiring pattern illustrated in FIG. 49. The wire width of a thin metallic wire was 0.5 μm, and the opening ratio was 99.7%.

### Comparative Example 1

Comparative Example 1 was a conductive film having a wiring pattern illustrated in FIG. 42. The wire width of a thin metallic wire was 3.0 μm, and the opening ratio was 98.0%.

### Comparative Example 2

Comparative Example 2 was a conductive film having a wiring pattern illustrated in FIG. 54. The wire width of a thin metallic wire was 3.0 μm, and the opening ratio was 98.0%.

### Comparative Example 3

Comparative Example 3 was a conductive film having a wiring pattern illustrated in FIG. 56. The wire width of a thin metallic wire was 3.0 μm, and the opening ratio was 98.0%.

### Comparative Example 4

Comparative Example 4 was a conductive film having a wiring pattern illustrated in FIG. 70. The wire width of a thin metallic wire was 3.0 μm, and the opening ratio was 98.0%.

### Comparative Example 5

Comparative Example 5 was a conductive film having a wiring pattern illustrated in FIG. 51. The wire width of a thin metallic wire was 3.0 μm, and the opening ratio was 98.0%.

### Comparative Example 6

Comparative Example 6 was a conductive film having a wiring pattern illustrated in FIG. 71. The wire width of a thin metallic wire was 3.0 μm, and the opening ratio was 98.0%.

### Comparative Example 7

Comparative Example 7 was a conductive film having a wiring pattern illustrated in FIG. 73. The wire width of a thin metallic wire was 3.0 μm, and the opening ratio was 98.0%.

### Comparative Example 8

Comparative Example 8 was a conductive film having a wiring pattern illustrated in FIG. 76. The wire width of a thin metallic wire was 3.0 μm, and the opening ratio was 98.0%.

### Comparative Example 9

Comparative Example 9 was a conductive film having a wiring pattern illustrated in FIG. 76. The wire width of a thin metallic wire was 2.0 μm, and the opening ratio was 98.7%.

### Comparative Example 10

Comparative Example 10 was a conductive film having a wiring pattern illustrated in FIG. 76. The wire width of a thin metallic wire was 1.0 μm, and the opening ratio was 99.3%.

The wiring pattern illustrated in FIG. 76 included a first wiring pattern 100 formed of thin metallic wires 36 and having rhombus openings 104, and a second wiring pattern 102 formed of thin metallic wires 36 and having rhombus openings 104. The rhombus opening 104 of the first wiring pattern 100 had the same size as the rhombus opening 104 of the second wiring pattern 102. A length Pa of one side of the opening 104 was 150 μm.

In Comparative Examples 8 to 10, in order to achieve a balance between moire visibility and noise visibility, producing and preparing a plurality of conductive films having different bias angles (formed between the thin metallic wire 36 of the first wiring pattern 100 and the thin metallic wire 36 of the second wiring pattern 102) during the pattern formation, and selecting a conductive film which can be evaluated to be A in the evaluation of model versatility among the films are included.

TABLE 1

| | | | | Wire | Opening | | | | |
|---|---|---|---|---|---|---|---|---|---|
| | First Wiring | Second Wiring | Coefficient | Width | Ratio | Model | Moire | Noise | Gloss |
| | Pattern | Pattern | of Variation | (μm) | (%) | Versatility | Visibility | Visibility | Visibility |
| Example 1 | type 01 edge | Center of Gravity | 39.2% | 3.0 | 98.0% | A | B | A | B |
| Example 2 | type 01 stan | Center of Gravity | 35.8% | 3.0 | 98.0% | A | B | A | A |
| Example 3 | type 02 | Center of Gravity | 31.5% | 3.0 | 98.0% | A | B | A | A |
| Example 4 | type 03 | Center of Gravity | 46.6% | 3.0 | 98.0% | A | B | B | A |
| Example 5 | type 04 | Center of Gravity | 33.7% | 3.0 | 98.0% | A | B | A | A |
| Example 6 | type 07 | Center of Gravity | 43.0% | 3.0 | 98.0% | A | A | B | A |
| Example 7 | type 08 | Center of Gravity | 43.6% | 3.0 | 98.0% | A | B | B | A |
| Example 8 | type 09 | Center of Gravity | 36.8% | 3.0 | 98.0% | A | A | B | A |
| Example 9 | type 10 | Center of Gravity | 32.1% | 3.0 | 98.0% | A | B | A | A |
| Example 10 | type 11 | Center of Gravity | 46.4% | 3.0 | 98.0% | A | A | B | A |
| Example 11 | type 12 | Center of Gravity | 35.0% | 3.0 | 98.0% | A | B | A | A |
| Example 12 | type 14 | Center of Gravity | 51.2% | 3.0 | 98.0% | A | B | B | A |
| Example 13 | type 15 | Center of Gravity | 46.8% | 3.0 | 98.0% | A | B | B | A |
| Example 14 | type 01 edge | Vertical Line | 42.5% | 3.0 | 98.0% | A | B | A | B |
| Example 15 | type 01 sp | Vertical Line | 39.2% | 3.0 | 98.0% | A | B | B | A |
| Example 16 | type 01 stan | Vertical Line | 41.5% | 3.0 | 98.0% | A | B | A | A |
| Example 17 | type 02 | Vertical Line | 51.1% | 3.0 | 98.0% | A | A | A | A |
| Example 18 | type 04 | Vertical Line | 39.4% | 3.0 | 98.0% | A | B | A | A |
| Example 19 | type 05 | Vertical Line | 33.1% | 3.0 | 98.0% | A | B | B | A |
| Example 20 | type 06 | Vertical Line | 43.6% | 3.0 | 98.0% | A | A | B | A |
| Example 21 | Type 07 | Vertical Line | 30.2% | 3.0 | 98.0% | A | A | B | A |
| Example 22 | type 08 | Vertical Line | 36.1% | 3.0 | 98.0% | A | A | B | A |
| Example 23 | type 09 | Vertical Line | 28.2% | 3.0 | 98.0% | A | A | B | A |
| Example 24 | type 10 | Vertical Line | 45.2% | 3.0 | 98.0% | A | A | B | A |
| Example 25 | type 11 | Vertical Line | 46.9% | 3.0 | 98.0% | A | A | B | A |
| Example 26 | type 12 | Vertical Line | 41.4% | 3.0 | 98.0% | A | A | B | A |
| Example 27 | type 14 | Vertical Line | 47.5% | 3.0 | 98.0% | A | A | B | A |
| Example 28 | type 02 | Center of Gravity | 31.5% | 2.5 | 98.3% | A | A | A | A |
| Example 29 | type 02 | Center of Gravity | 31.5% | 2.0 | 98.7% | A | A | A | A |
| Example 30 | type 02 | Center of Gravity | 31.5% | 1.5 | 99.0% | A | A | A | A |
| Example 31 | type 02 | Center of Gravity | 31.5% | 1.0 | 99.3% | A | A | A | A |
| Example 32 | type 02 | Center of Gravity | 31.5% | 0.5 | 99.7% | A | A | A | A |
| Example 33 | type 02 | Vertical Line | 51.1% | 2.5 | 98.3% | A | A | A | A |
| Example 34 | type 02 | Vertical Line | 51.1% | 2.0 | 98.7% | A | A | A | A |
| Example 35 | type 02 | Vertical Line | 51.1% | 1.5 | 99.0% | A | A | A | A |
| Example 36 | type 02 | Vertical Line | 51.1% | 1.0 | 99.3% | A | A | A | A |
| Example 37 | type 02 | Vertical Line | 51.1% | 0.5 | 99.7% | A | A | A | A |
| Comparative | type 01 sp | Center of Gravity | 57.5% | 3.0 | 98.0% | D | A | C | A |
| Example 1 | | | | | | | | | |
| Comparative | type 05 | Center of Gravity | 73.4% | 3.0 | 98.0% | D | B | D | A |
| Example 2 | | | | | | | | | |
| Comparative | type 06 | Center of Gravity | 66.7% | 3.0 | 98.0% | D | A | C | A |
| Example 3 | | | | | | | | | |
| Comparative | type 13 | Center of Gravity | 57.8% | 3.0 | 98.0% | D | A | C | A |
| Example 4 | | | | | | | | | |
| Comparative | type 03 | Vertical Line | 70.9% | 3.0 | 98.0% | D | A | C | A |
| Example 5 | | | | | | | | | |
| Comparative | type 13 | Vertical Line | 53.1% | 3.0 | 98.0% | D | B | C | A |
| Example 6 | | | | | | | | | |
| Comparative | type 15 | Vertical Line | 58.3% | 3.0 | 98.0% | D | B | C | A |
| Example 7 | | | | | | | | | |
| Comparative | Rhombus | Rhombus | 0% | 3.0 | 98.0% | A | A | A | D |
| Example 8 | | | | | | | | | |
| Comparative | Rhombus | Rhombus | 0% | 2.0 | 98.7% | A | A | A | C |
| Example 9 | | | | | | | | | |
| Comparative | Rhombus | Rhombus | 0% | 1.0 | 99.3% | A | A | A | C |
| Example 10 | | | | | | | | | |

As shown in Table 1, Examples 1 to 37 obtained good results in the moire visibility, noise visibility, and gloss visibility as compared with Comparative Examples 1 to 10. Furthermore, model versatility was also provided, and good results were obtained in the moire visibility and noise visibility regardless of the resolution of the display unit.

In Comparative Examples 1 to 7, the coefficient of variation was large, the noise visibility deteriorated, and the suppression of the occurrence of moire and the suppression of the occurrence of noise were not balanced. In comparative Examples 8 to 10, although the opening had a rhombus shape and the coefficient of variation was 0%, the gloss visibility deteriorated.

In a case where the first wiring pattern was type 01 edge (Examples 1 and 14), type 01 stan (Examples 2 and 16), type 02 (Examples 3, 17, 28 to 37), type 04 (Examples 5 and 18), type 07 (Examples 6 and 21), type 09 (Examples 8 and 23), type 10 (Examples 9 and 24), type 11 (Examples 10 and 25), or type 12 (Examples 11 and 26), good results were obtained in the moire visibility or noise visibility in any one of the center of gravity pattern and the vertical pattern, or in both of the patterns.

### Explanation of References

10: conductive film
10a, 12a: front surface
12: protective layer
13: touch sensor
14: detector
16: touch panel
18: optically transparent layer
20: display device
22: display unit
24: display equipment
26: pixel
26b: blue sub-pixel
26g: green sub-pixel
26r: red sub-pixel
27: black matrix
28: black matrix pattern
30, 31: transparent base
30a, 31a: front surface
30b: rear surface
30c: one side
32: first conductive portion
33: first peripheral wire
34: second conductive portion
35: second peripheral wire
36: thin metallic wire
37: sensor region
38: adhesive layer
39: terminal
40, 40a, 40b, 40c, 40d, 40e, 40f, 40g, 40h, 40j, 40k, 40m, 40n, 40p, 40r, 43: congruent convex pentagon (convex pentagon)
41, 41a, 41b, 41c, 41d, 41e, 41f, 41g, 41h, 41j, 41k, 41m, 41n, 41p, 41r, 43a, 51, 53, 55, 62, 63: opening
42, 42a, 42b, 42c, 42d, 42e, 42f, 42g, 42h, 42j, 42k, 42m, 42n, 42p, 42r, 43b: first wiring pattern
43c: repeating unit
44: visible outline
45: region
47: straight line
50, 52: second wiring pattern
57, 57a, 57b, 57c, 57d: perpendicular bisector
100: first wiring pattern
102: second wiring pattern
104: opening
60: opening group
D1: first direction
D2: second direction
D3: lamination direction
Dn: vertical direction
G: center of gravity
Pv: vertical pixel pitch
Ph: horizontal pixel pitch
t: thickness
w: wire width

What is claimed is:

1. A conductive film which is installed on a display unit of a display device, the conductive film comprising:
a first conductive portion having a first wiring pattern in which a plurality of first openings of congruent convex pentagons constituted by thin metallic wires are arranged; and
a second conductive portion disposed in the form of a layer to overlap at least a part of the first conductive portion with a gap therebetween,
wherein the second conductive portion has a second wiring pattern in which a plurality of openings constituted by thin metallic wires are provided, and
when viewed in a lamination direction in which the first conductive portion and the second conductive portion overlap each other, a coefficient of variation of an opening area is less than 52% in an opening group formed by the first wiring pattern of the first conductive portion and the second wiring pattern of the second conductive portion.

2. The conductive film according to claim 1,
wherein the opening of the second wiring pattern of the second conductive portion has a polygonal shape and has an apex at a center of gravity position of the first opening of the congruent convex pentagon.

3. The conductive film according to claim 1,
wherein the opening of the second wiring pattern of the second conductive portion has a polygonal shape, and a perpendicular bisector of each side of the first opening of the congruent convex pentagon constitutes at least one of sides of the opening.

4. The conductive film according to claim 1,
wherein the convex pentagon has a side a, a side b, a side c, a side d, and a side e, and satisfies angle A+angle B+angle C=180° in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a, and
the side b of the convex pentagon and the side c of the convex pentagon are matched, and the side e is disposed on a straight line.

5. The conductive film according to claim 1,
wherein the convex pentagon has a side a, a side b, a side c, a side d, and a side e, and satisfies angle A+angle B+angle C=180° in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a, and
the sides b of the plurality of convex pentagons and the sides c of the plurality of convex pentagons are matched, and the sides e of the plurality of convex pentagons are disposed by changing a predetermined distance from a straight line.

6. The conductive film according to claim 1,
wherein the convex pentagon has a side a, a side b, a side c, a side d, and a side e, and satisfies angle A+angle B+angle D=180° and side a=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

7. The conductive film according to claim 1,
wherein the convex pentagon has a side a, a side b, a side c, a side d, and a side e, and satisfies angle C=angle E=90°, side a=side e, and side c=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

8. The conductive film according to claim 1,
wherein the convex pentagon has a side a, a side b, a side c, a side d, and a side e, and satisfies angle B×2+angle C=360°, angle D×2+angle A=360°, and side a=side b=side c=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

9. The conductive film according to claim 1,
wherein the convex pentagon has a side a, a side b, a side c, a side d, and a side e, and satisfies angle E×2+angle B=360°, angle D×2+angle C=360°, and side a=side b=side c=side d in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

10. The conductive film according to claim 1,
wherein the convex pentagon has a side a, a side b, a side c, a side d, and a side e, and satisfies angle A=90°, angle B+angle E=180°, angle D×2+angle E=360°, angle C×2+angle B=360°, and side a=side b=(side c+side e) in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

11. The conductive film according to claim 1,
wherein the convex pentagon has a side a, a side b, a side c, a side d, and a side e, and satisfies angle A=90°, angle C+angle E=180°, angle B×2+angle C=360°, and side d=side e=(side a×2+side c) in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

12. The conductive film according to claim 1,
wherein the convex pentagon has a side a, a side b, a side c, a side d, and a side e, and satisfies angle A=90°, angle C+angle E=180°, angle B×2+angle C=360°, and side a×2=side d=(side c+side e) in a case where an angle A is an angle formed between the side a and the side b, an angle B is an angle formed between the side b and the side c, an angle C is an angle formed between the side c and the side d, an angle D is an angle formed between the side d and the side e, and an angle E is an angle formed between the side e and the side a.

13. The conductive film according to claim 1,
wherein the thin metallic wire has a wire width of 0.5 μm to 5 μm.

14. The conductive film according to claim 1,
wherein the first conductive portion is provided on one surface of a transparent base, and the second conductive portion is provided on the other surface of the transparent base.

15. The conductive film according to claim 1,
wherein the first wiring pattern and the second wiring pattern are superimposed on a pixel arrangement pattern of the display unit.

16. The conductive film according to claim 15,
wherein the pixel arrangement pattern is a black matrix pattern of the display unit.

17. A touch panel comprising:
the conductive film according to claim 1 which is disposed on a display unit of a display device.

18. A touch sensor which is installed on a display unit of a display device, the touch sensor comprising:
a first conductive portion having a first wiring pattern in which a plurality of first openings of congruent convex pentagons constituted by thin metallic wires are arranged; and
a second conductive portion disposed in the form of a layer to overlap at least a part of the first conductive portion with a gap therebetween,
wherein the second conductive portion has a second wiring pattern in which a plurality of openings constituted by thin metallic wires are provided, and
when viewed in a lamination direction in which the first conductive portion and the second conductive portion overlap each other, a coefficient of variation of an opening area is less than 52% in an opening group formed by the first wiring pattern of the first conductive portion and the second wiring pattern of the second conductive portion.

19. A touch panel which is installed on a display unit of a display device, the touch panel comprising:
a first conductive portion having a first wiring pattern in which a plurality of first openings of congruent convex pentagons constituted by thin metallic wires are arranged; and
a second conductive portion disposed in the form of a layer to overlap at least a part of the first conductive portion with a gap therebetween,
wherein the second conductive portion has a second wiring pattern in which a plurality of openings constituted by thin metallic wires are provided, and
when viewed in a lamination direction in which the first conductive portion and the second conductive portion overlap each other, a coefficient of variation of an opening area is less than 52% in an opening group formed by the first wiring pattern of the first conductive portion and the second wiring pattern of the second conductive portion.
